(19) United States
(12) Patent Application Publication
(10) Pub. No.: US 2013/0329173 A1
(43) Pub. Date: Dec. 12, 2013

(54) LIQUID CRYSTAL PROTECTION COVER FOR PORTABLE TERMINAL AND METHOD OF MANUFACTURING TRANSMISSION PROTECTION LAYER FORMING THE SAME

(71) Applicant: Sung Pyo Jung, Daegu (KR)

(72) Inventor: Sung Pyo Jung, Daegu (KR)

(73) Assignee: MOBITECH.CO.,LTD., Gumi city (KR)

(21) Appl. No.: 13/805,083

(22) PCT Filed: Oct. 21, 2011
(86) PCT No.: PCT/KR11/07883

§ 371 Date: Dec. 18, 2012

(30) Foreign Application Priority Data
Feb. 28, 2011 (KR) 10-2011-0017842
Mar. 11, 2011 (KR) 10-2011-0022120
May 13, 2011 (KR) 10-2011-0045094
Jul. 7, 2011 (KR) 10-2011-0067160

(51) Int. Cl. G02F 1/1333

(52) U.S. Cl. CPC G02F 1/1333
USPC 349/122; 156/278; 156/277; 156/313; 156/275.5

(57) ABSTRACT

Disclosed are a liquid crystal protection cover which is mounted to an upper surface of a display window of a portable terminal to protect a liquid crystal part and a display window, is easily detachably attached to the portable terminal according to a taste of a user, the liquid crystal protection cover having various patterns and colors, and interrupts electronic waves generated in the portable terminal to minimize a harmful effect of the electronic waves on a human body, and a method of manufacturing a transmission protection layer forming the same.

### BACKGROUND OF THE INVENTION

1. Field of the Invention

The present invention relates to a liquid crystal protection cover for a portable terminal and a method of manufacturing a transmission protection layer forming the same, and more particularly to a liquid crystal protection cover for a portable terminal which is mounted to an upper portion of a display window of the portable terminal to protect a liquid crystal part and a display window while decorating the liquid crystal part and the display window and a method of manufacturing a transmission protection layer forming the same.

2. Description of the Related Art

Due to development of wireless communication technologies, portable terminals such as tablet PCs are becoming small-sized and complex, and thus mechanical characteristics as well as electrical characteristics of portable terminals are required to be highly reliable. In recent years, portable communication terminals in which a mobile phone function of allowing the user to communicate with a general phone or a mobile communication terminal through a base station while moving and a computer supporting function of allowing the user to install a desired application while the portable communication terminals being connected to the wireless Internet are integrated, that is, smart phones and tablet PCs are popular.

In order to effectively use the computer support function, a liquid crystal part of a smart phone should be relatively wide and a strength of a display window covering an upper portion of the liquid crystal part should be high to minimize damage to the smart phone due to an external impact. That is, unlike the other mobile phones, in the smart phone, since the liquid crystal part and the display window themselves on which the computer supporting function is displayed are an important factor, it is important to maintain the liquid crystal part and the display window clearly and in a state in which an external impact can be endured for a long time. To this end, the display window of the smart phone is generally manufactured of a glass window.

However, in spite that the display window of the smart phone is formed of a glass plate, scratches are often generated on a surface of the display window due to frictions by fingernails or other foreign substances or the display window is often broken due to a strong external impact in the process of touching a button.

As mentioned above, since the liquid crystal part and the display window are very important parts due to the characteristics of the smart phone, the liquid crystal part or the display window needs to be replaced as a following measure if the liquid crystal part or the display window is damaged, in which case costs for replacing the liquid crystal part or the display window is so high that many technologies for protecting them before the liquid crystal part or the display window is damaged have been developed and used.

In this way, a representative technology for protecting a liquid crystal part and a display window includes a method of attaching a protection film on a surface of the display window.

The method of protecting the liquid crystal part and the display window by using the protection film interrupts frictions due to foreign substances to prevent generation of scratches, but still causes the liquid crystal part and the display window to be damaged as it does not provide against a strong impact. Further, since the portable terminal according to the related art is released while the pattern and color thereof displayed to the outside through the display window remains unchanged, it cannot cope with the tastes of the users requiring various patterns and colors. In addition, electronic waves generated in the portable terminal are transferred to the human body as they are during the use of the portable terminal, and the electronic waves are transferred to the brain of the user as they are through the speaker of the portable terminal closest to the human body during a voice communication, causing a more serious damage.

### SUMMARY OF THE INVENTION

Accordingly, the present invention has been made keeping in mind the above problems occurring in the prior art, and an object of the present invention is to provide a liquid crystal protection cover which is mounted to an upper surface of a display window of a portable terminal to protect a liquid crystal part and a display window, is easily detachably attached to the portable terminal according to a taste of a user, the liquid crystal protection cover having various patterns and colors, and interrupts electronic waves generated in the portable terminal to minimize a harmful effect of the electronic waves on a human body, and a method of manufacturing a transmission protection layer forming the same.

In accordance with one aspect of the present invention, there is provided a liquid crystal protection cover coupled to an upper surface of a portable terminal having a liquid crystal part at an upper portion thereof and in which a display window covering an upper portion of the liquid crystal part is mounted to an upper surface thereof to protect the liquid crystal part and the display window, the liquid crystal protection cover including: a transmission protection layer disposed on the display window; and an adhesive layer disposed under the transmission protection layer to bond the transmission protection layer to an upper surface of the portable terminal.

A pattern layer may be coupled to a lower surface of the transmission protection layer in an area other than an area corresponding to the liquid crystal part, an upper surface and a lower surface of the adhesive layer may have a bonding property, the upper surface of the adhesive layer may be bonded to a lower surface of the pattern layer, a lower release layer may be coupled to the lower surface of the adhesive layer, and the lower surface of the adhesive layer may be bonded to an upper surface of the display window of the portable terminal after the lower release layer is delaminated.

A pattern layer may be coupled to an upper surface of the transmission protection layer in an area other than an area corresponding to the liquid crystal part, an upper surface and a lower surface of the adhesive layer may have a bonding property, the upper surface of the adhesive layer may be bonded to a lower surface of the transmission protection layer, a lower release layer may be coupled to the lower surface of the adhesive layer, and the lower surface of the adhesive layer may be bonded to an upper surface of the display window of the portable terminal after the lower release layer is delaminated.

The adhesive layer may be detachably bonded to the display window of the portable terminal, and a bonding force of the lower surface of the adhesive layer may be smaller than a bonding force of the upper surface of the adhesive layer so that the adhesive layer is bonded to a lower surface of the transmission protection layer when the transmission protection layer is separated from the display window.

A width of the adhesive layer may be smaller than a width of the pattern layer at a portion where the adhesive layer is disposed under the pattern layer.

The transmission protection layer may be formed of any one of a tempered glass, a transmitting plastic, and a synthetic resin film, and may have a same size as that of the display window.

The pattern layer may be formed on the transmission protection layer through printing or deposition.

An exposure hole for exposing at least one of a push button and speaker mounted to the portable terminal may be formed in the transmission protection layer, and the pattern layer and the adhesive layer may be empty at a portion corresponding to the exposure hole.

The exposure hole may be formed to expose the push button to the outside, and a press button for pressing the push button may be mounted to the exposure hole.

The pattern layer may be coupled to the transmission protection layer, and the pattern layer may not be coupled to the transmission protection layer in an area corresponding to a camera mounted to the portable terminal and in an area corresponding to the liquid crystal part.

The transmission protection layer may be formed of a tempered glass, a non-coated film layer is attached to an entire lower surface of the transmission protection layer, and the pattern layer may be coupled to a lower surface of the film layer in an area other than an area corresponding to the liquid crystal part.

An UV paint may be applied to an upper surface or a lower surface of the film layer to form a convexo-concave portion.

A penetration hole having a size corresponding to a size of the liquid crystal part may be formed in the transmission protection layer, and the adhesive layer may be detachably bonded to the portable terminal.

The liquid crystal protection cover may further include: a transparent body inserted and coupled into the penetration hole of the transmission protection layer. The adhesive layer may bond a lower surface of the transmission protection layer and a lower surface of the transparent body to an upper surface of the portable terminal, an avoidance hole may be formed in the adhesive layer, and a size of the avoidance hole may be smaller than a size of the transparent body.

The liquid crystal protection cover may further include: a transparent body inserted and coupled into the penetration hole of the transmission protection layer. The transparent body may include an insertion portion inserted into the penetration hole; and a lower end portion formed at a lower portion of the insertion portion, having a size larger than that of the insertion portion, and in which the transmission protection layer is positioned on a periphery upper portion thereof, and the adhesive layer may include a first adhesive layer bonding a lower portion of the lower end portion to the portable terminal; and a second adhesive layer bonding the transmission protection layer to a peripheral upper surface of the lower end portion.

An opaque strip decoration may be formed at a periphery of the transparent body, and the strip decoration may cover an inner portion of the adhesive layer disposed under the transparent body.

The transmission protection layer may be formed of a metal material.

The transmission protection layer may include a support portion having a recess on an upper surface thereof; and a decoration portion inserted and mounted into the recess.

A height of an outer side of the support portion forming the recess may be lower than a height of the decoration portion.

A magnet may be mounted between the decoration portion and the recess to couple the decoration portion to the recess.

The liquid crystal protection cover may further include: a shielding member coupled to the transmission protection layer or the display window to interrupt or absorb electronic waves generated in the portable terminal.

The shielding member may include a shielding sheet disposed between the transmission protection layer and the display window to cover an upper surface of the display window other than the liquid crystal part, and the transmission protection layer may be coupled to the display window through the shielding sheet.

The adhesive layer may include a first adhesive portion coupling the transmission protection layer and the shielding member, and a second adhesive portion detachably coupling the shielding member to an upper surface of the display window.

The second adhesive portion may include a tape opposite surfaces of which have a bonding property, and a bonding force of a surface of the second adhesive portion contacting the shielding member may be stronger than a bonding force of a surface of the second adhesive portion contacting the display window.

The adhesive layer and the shielding member may have a same configuration, and the shielding member may have a bonding property to couple the transmission protection layer to the display window.

The shielding member may include a conductive shielding net, the shielding net may be coupled to the display window while covering a speaker of the portable terminal, a second through-hole inserted into the shielding net may be formed in the transmission protection layer, and the transmission protection layer may be coupled to the display window by the second adhesive portion.

The shielding member may include: a shielding sheet disposed between the transmission protection layer to cover an upper surface of the display window other than the liquid crystal part; and a conductive shielding net coupled to the display window while covering a speaker of the portable terminal, the transmission protection layer may be coupled to the display window while covering the shielding sheet, a first through-hole into which the shielding net is inserted is formed in the shielding sheet, and a second through-hole into which the shielding net is inserted may be formed in the transmission protection layer.

The shielding member may include a conductive ink layer applied to a lower surface of the transmission protection layer to interrupt or absorb electronic waves, and the conductive ink layer may be coupled to an upper surface of the display window by the second adhesive portion.

The adhesive layer may include a double-sided adhesive sheet coupled to a lower surface of the transmission protection layer to couple the transmission protection layer to the display window, the double-sided adhesive sheet may be disposed adjacent to the shielding member horizontally, and the shielding member may be disposed on a side opposite to a side of the display window where an antenna of the portable terminal is disposed.

The transmission protection layer may be formed of any one of a tempered glass, a tempered plastic, and a synthetic resin film, and the shielding member may be coupled to a lower surface of the transmission protection layer or an upper surface of the display window.

The transmission protection layer may include: a first film; a second film facing the first film and bonded to the display window of the portable terminal; an information printing layer inserted between the first film and the second film; and a glue layer applied between the first film and the second film to bond the first film and the second film to each other, for closing a circumference of the information printing layer.

The information printing layer may include a surface treatment layer printed, deposited, or coated on the first film or the second film.

The information printing layer may be formed of a thin film plate of paper or a metal inserted between the first film and the second film.

An ultraviolet glue layer may be coated on a bottom surface of the second film to be hardened.

In accordance with another aspect of the present invention, there is provided a method of manufacturing a transmission protection layer of a liquid crystal protection cover for a portable terminal, the method including: preparing a first film and a second film; printing, coating, or depositing an information printing layer on the first film or the second film; and combining the first film and the second film through lamination.

In accordance with yet another embodiment of the present invention, there is provided a method of manufacturing a transmission protection layer of a liquid crystal protection cover for a portable terminal, the method including: preparing a first film and a second film; applying a glue between the first film and the second film; inserting an information printing layer between the first film or the second film; and combining the first film and the second film through lamination.

The method may further include: coating an ultraviolet ray glue layer on a bottom surface of the second film and hardening the ultraviolet ray glue layer with an ultraviolet ray hardener.

The liquid crystal protection cover according to the present invention is mounted to an upper surface of the display window to protect the liquid crystal part and the display window, and exhibits various patterns and colors due to the pattern layer so that the cover can be easily attached to and detached from the portable terminal to be replaced according to a taste of a user.

Further, as the transparent body is inserted into the penetration hole of the transmission protection layer, the liquid crystal part of the portable terminal can be prevented from being broken or flawed by an impact or a pressure applied to the liquid crystal part.

Since a size of the avoidance hole formed in the adhesive layer is smaller than a size of the transparent body, the transparent body and the transmission protection layer can be detachably bonded to an upper surface of the portable terminal at once by using one adhesive layer. Further, since the adhesive layer formed in the avoidance hole bonds only a peripheral surface of a lower surface of the transparent body to the portable terminal, a letter, an image, and the like displayed through the liquid crystal part can be clearly expressed to the outside.

By bonding and coupling the transmission protection layer to a periphery of an upper portion of the transparent body and bonding and coupling a lower portion of the transmission protection layer to an entire upper surface of the portable terminal, an external force can be dispersed to the liquid crystal part at an upper portion of the insertion portion when the external force is applied, stably protecting the liquid crystal part and the upper surface of the portable terminal.

The decoration part is detachably bonded to the support portion forming the recess of the transmission protection layer to be easily exchanged, while showing a decoration effect. Further, an aesthetic feeling and a touch feeling can become different by making an outer surface of the support portion lower than the decoration portion.

Since the decoration portion is inserted and bonded into the recess by a magnetic force of the magnet, the decoration portion can be easily replaced.

Thus, the portable terminal can be decorated by a unique design according to a taste of a consumer. Further, the liquid crystal part can be easily protected from an external impact and a surface of the liquid crystal part can be prevented from being flawed.

Further, a harmful effect of electronic waves on a human body can be minimized by interrupting electronic waves generated in the portable terminal by the shielding member. In particular, since the shielding member is coupled to the transmission protection layer contacting the face of a user, electronic waves can be interrupted from propagating to the head of the user during a voice communication.

### BRIEF DESCRIPTION OF THE DRAWINGS

The above and other objects, features and other advantages of the present invention will be more clearly understood from the following detailed description when taken in conjunction with the accompanying drawings, in which:

FIG. 1 is a perspective view showing a state in which a liquid crystal protection cover for a portable terminal according to a first embodiment of the present invention is coupled to a portable terminal;

FIG. 2 is a perspective view showing a state in which the liquid crystal protection cover for a portable terminal according to the first embodiment of the present invention is separated from the portable terminal;

FIG. 3 is an exploded perspective view of the liquid crystal protection cover for a portable terminal according to the first embodiment of the present invention;

FIG. 4 is a sectional view taken along line A-A of FIG. 1;

FIG. 5 is a sectional view taken along line B-B of FIG. 1;

FIG. 6 is an exploded perspective view of a liquid crystal protection cover for a portable terminal according to another first embodiment of the present invention;

FIG. 7 is a sectional view of the liquid crystal protection cover for a portable terminal according to the another first embodiment of the present invention;

FIG. 8 is a perspective view of a liquid crystal protection cover for a portable terminal according to a second embodiment of the present invention;

FIG. 9 is an exploded perspective view of a liquid crystal display cover for a portable terminal according to the second embodiment of the present invention;

FIG. 10 is a sectional view taken along line C-C of FIG. 8 according to the second embodiment of the present invention;

FIG. 11 is a perspective view of a liquid crystal protection cover for a portable terminal according to a third embodiment of the present invention;

FIG. 12 is an exploded perspective view of the liquid crystal protection cover for a portable terminal according to the third embodiment of the present invention;

FIG. 13 is a sectional view taken along line D-D of FIG. 11 according to the third embodiment of the present invention;

FIG. 14 is a perspective view of a liquid crystal protection cover for a portable terminal according to a fourth embodiment of the present invention;

FIG. 15 is an exploded perspective view of the liquid crystal protection cover according to the fourth embodiment of the present invention;

FIG. 16 is a sectional view taken along line E-E of FIG. 14 according to the fourth embodiment of the present invention;

FIG. 17 is a sectional view showing another structure of a transmission according to the fourth embodiment of the present invention;

FIG. 18 is a perspective view showing a state in which a liquid crystal protection cover for a portable terminal according to a fifth embodiment of the present invention is coupled to a portable terminal;

FIG. 19 is a perspective view showing a state in which the liquid crystal protection cover for a portable terminal according to the fifth embodiment of the present invention is separated from the portable terminal;

FIG. 20 is an exploded perspective view of the liquid crystal protection cover for a portable terminal according to the fifth embodiment of the present invention;

FIG. 21 is a sectional view taken along line F-F of FIG. 18 according to the fifth embodiment;

FIG. 22 is an exploded perspective view of a liquid crystal protection cover according to a sixth embodiment of the present invention;

FIG. 23 is a sectional view showing a state in which the liquid crystal protection cover according to the sixth embodiment of the present invention is mounted to a portable terminal;

FIG. 24 is an exploded perspective view of a liquid crystal protection cover for a portable terminal according a seventh embodiment of the present invention;

FIG. 25 is a sectional view showing a state in which the liquid crystal protection cover for a portable terminal according the seventh embodiment of the present invention;

FIG. 26 is an exploded perspective view of a liquid crystal protection cover for a portable terminal according an eighth embodiment of the present invention;

FIG. 27 is a sectional view showing a state in which the liquid crystal protection cover for a portable terminal according the eighth embodiment of the present invention;

FIG. 28 is an exploded perspective view of a liquid crystal protection cover for a portable terminal according a ninth embodiment of the present invention;

FIG. 29 is a sectional view showing a state in which the liquid crystal protection cover for a portable terminal according the ninth embodiment of the present invention;

FIG. 30 is an exploded perspective view of a liquid crystal protection cover for a portable terminal according a tenth embodiment of the present invention;

FIG. 31 is a sectional view showing a state in which the liquid crystal protection cover for a portable terminal according the tenth embodiment of the present invention;

FIG. 32 is an exploded sectional view of a transmission protection layer according to an eleventh embodiment of the present invention;

FIG. 33 is a sectional view showing a coupled state of the transmission protection layer shown in FIG. 32; and

FIG. 34 is a sectional view showing a state in which an ultraviolet ray adhesive is applied to the transmission protection layer shown in FIG. 32.

### DETAILED DESCRIPTION OF THE INVENTION

Hereinafter, a first embodiment of the present invention will be described.

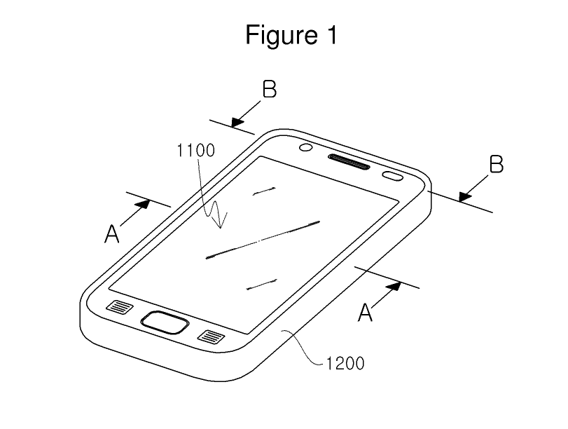

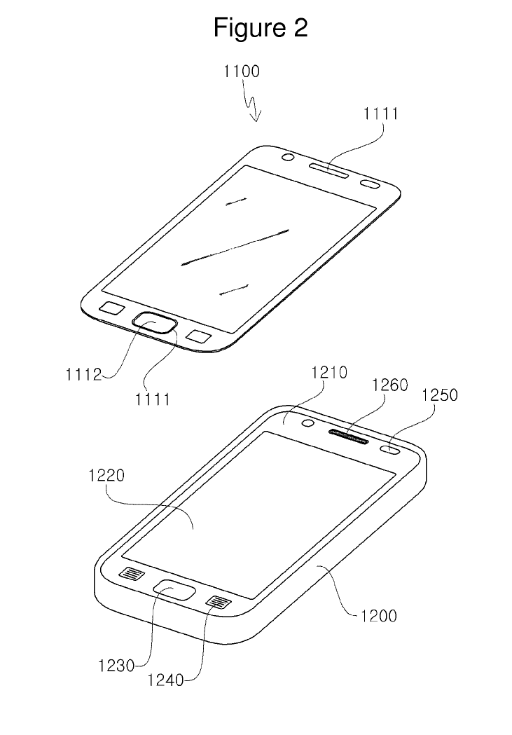

FIG. 1 is a perspective view showing a state in which a liquid crystal protection cover for a portable terminal according to a first embodiment of the present invention is coupled to a portable terminal. FIG. 2 is a perspective view showing a state in which the liquid crystal protection cover for a portable terminal according to the first embodiment of the present invention is separated from the portable terminal.

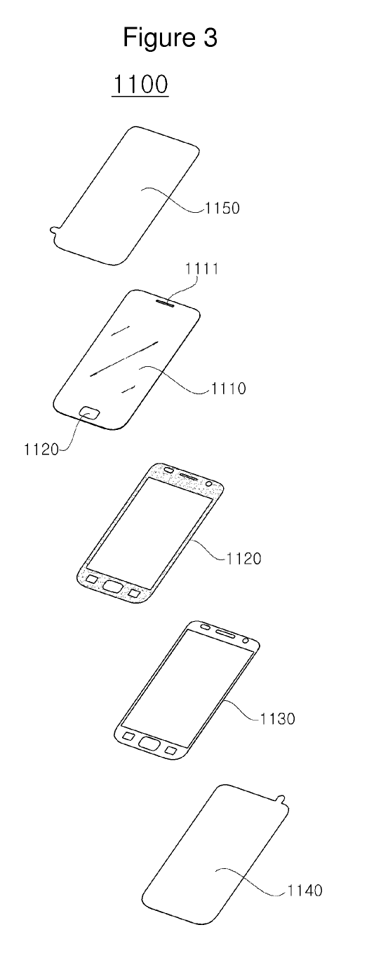

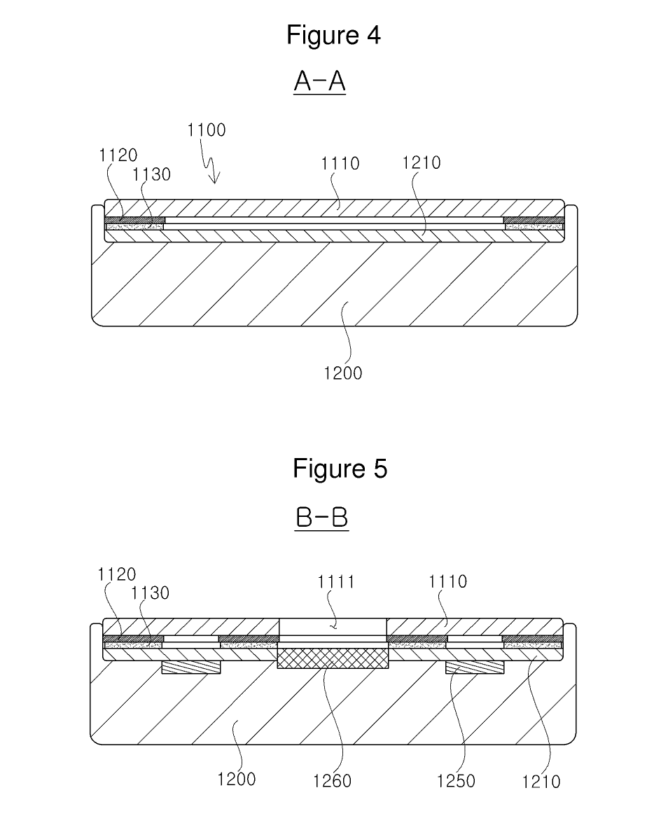

FIG. 3 is an exploded perspective view of the liquid crystal protection cover for a portable terminal according to the first embodiment of the present invention. FIG. 4 is a sectional view taken along line A-A of FIG. 1. FIG. 5 is a sectional view taken along line B-B of FIG. 1.

As shown in FIGS. 1 and 2, the liquid crystal protection cover 1100 for a portable terminal is coupled to an upper surface of a portable terminal 1200 having a liquid crystal part 1220 such as an LCD at an upper portion thereof and in which a display window 1210 covering an upper portion of the liquid crystal part 1220 is mounted to an upper surface thereof to protect the liquid crystal part 1220 and the display window 1210.

As shown in FIGS. 3 to 5, the liquid crystal protection cover 1100 includes a transmission protection layer 1110, a pattern layer 1120, an adhesive layer 1130, a lower release layer 1140, and an upper release layer 1150.

The transmission protection layer 1110 is formed of a transparent tempered glass, a transmitting plastic or a synthetic resin film, has the same or substantially the same size as that of the display window 1210 of the portable terminal 1200, and is laminated on the display window 1210.

The display window 1210 is generally formed of a tempered glass or a transmitting plastic to protect the liquid crystal part 1220, and covers an entire upper surface of the portable terminal 1200.

An exposure hole 1111 for exposing a push button 1230 mounted to the portable terminal 1200 and/or a speaker 1260 to the outside is formed in the transmission protection layer 1110. Then, a press button 1112 for pressing the push button 1230 is mounted to the exposure hole 1111 so that the push button 1230 can be pressed better.

An upper surface and/or a lower surface of the transmission protection layer 1110 may be anti-fingerprint coated to prevent a handprint from being easily left.

The pattern layer 1120 is formed on an upper surface or a lower surface of the transmission protection layer 1110 through silk printing or deposition, is coupled to an area of a lower surface of the transmission protection layer 1110 other than an area corresponding to the liquid crystal part 1220 in which an image is displayed.

The pattern layer 1120 may be coupled to an upper surface or a lower surface of the transmission protection layer 1110, and may be preferably coupled to a lower surface of the transmission protection layer 1110. The pattern layer 1120 has various colors and/or patterns, to diversify a color and a pattern of the cover 1110 of the present invention.

A portion of the pattern layer 1120 corresponding to the exposure hole 1111 is empty. That is, the pattern layer 1120 is not formed at a portion where the exposure hole 1111 is formed.

The pattern layer 1120 is coupled to the transmission protection layer 1110 in areas corresponding to a touch button 1240 and a camera 1250 mounted to the portable terminal 1200 and an area other than an area corresponding to the liquid crystal part 1220. That is, the pattern player 1120 is not formed in areas corresponding to the touch button 1240, the camera 1250, and the liquid crystal part 1220 exposed from an upper surface of the portable terminal 1200 so that the touch button 1240, the camera 1250, and the liquid crystal part 1220, as well as the exposure hole 1111.

Thus, as shown in FIG. 3, portions of the pattern layer 1120 corresponding to the liquid crystal part 1220, the exposure hole 1111, and the camera 1250 are empty.

An upper surface and a lower surface of the adhesive layer 1130 have a bonding property, and an upper surface of the adhesive layer 1130 is bonded to a lower surface of the pattern layer 1120. The adhesive layer 1130 is formed of a material such as a double-sided tape.

Unlike the embodiment, when the pattern layer 1120 is coupled to an upper surface of the transmission protection layer 1110, an upper surface of the adhesive layer 1130 is bonded to a lower surface of the transmission protection layer 1110.

The lower release layer 1140 is initially coupled to a lower surface of the adhesive layer 1130, and after the user delaminates the lower release layer 1140, a lower surface of the adhesive layer 1130 is attached to an upper surface of the display window 1210 of the portable terminal 1200.

Further, the adhesive layer 1130 is formed such that a bonding force of the upper surface thereof is stronger than a bonding force of the lower surface thereof. That is, the adhesive layer 1130 is formed such that a bonding force of the pattern layer 1120 is stronger than a bonding force of the portable terminal 1200.

When the cover body 1100 of the present invention is separated from the portable terminal 1200, the bonding layer 1130 is not attached to the portable terminal 1200 but remains stuck to the pattern layer 1120 due to a difference between bonding forces of upper and lower surfaces of the adhesive layer 1130, in which case remnants of the adhesive layer 1130 are prevented from being left on the portable terminal 1200 while staining the portable terminal 1200.

Since a bonding force of a lower surface of the bonding layer 1130 is weaker than that of an upper surface thereof, the cover 1100 of the present invention can be detachably bonded to the display window 1210 of the portable terminal 1200, and the user can easily separate the cover 1100 of the present invention from the portable terminal 1200 to replace the cover 1100.

Further, a width of the adhesive layer 1130 is smaller than a width of the pattern layer 1120 at a portion where the adhesive layer 1130 is disposed under the pattern layer 1120.

As in the embodiment, an upper surface of the adhesive layer 1130 is coupled to a lower surface of the pattern layer 1120, a width of the adhesive layer 1130 is smaller than a width of the pattern layer 1120 at a portion where the adhesive layer 1130 is coupled to a lower surface of the pattern layer 1120. That is, an entire size of the adhesive layer 1130 is slightly smaller than an entire size of the pattern layer 1120. This is because when the cover 1100 is pressed to be attached to an upper surface of the portable terminal 1200, the adhesive layer 1130 can be prevented from being coming out to the outside of the pattern layer 1120 to be exposed to the outside by a pressing force.

Further, the adhesive layer 1130 is empty at a portion such as the pattern layer 1120 corresponding to the exposure hole 1111.

As described above, the lower release layer 1140 is coupled to a lower surface of the adhesive layer 1130 when the product is released, and is delaminated from the adhesive layer 1130 when the cover 1100 of the present invention is to be attached to the portable terminal 1200.

Further, like the lower release layer 1140, the upper release layer 1150 is coupled to an upper surface of the transmission protection layer 1110 when the product is released, and is finally delaminated after the user attaches the cover 1100 of the present invention to the portable terminal 1200 through the adhesive layer 1130.

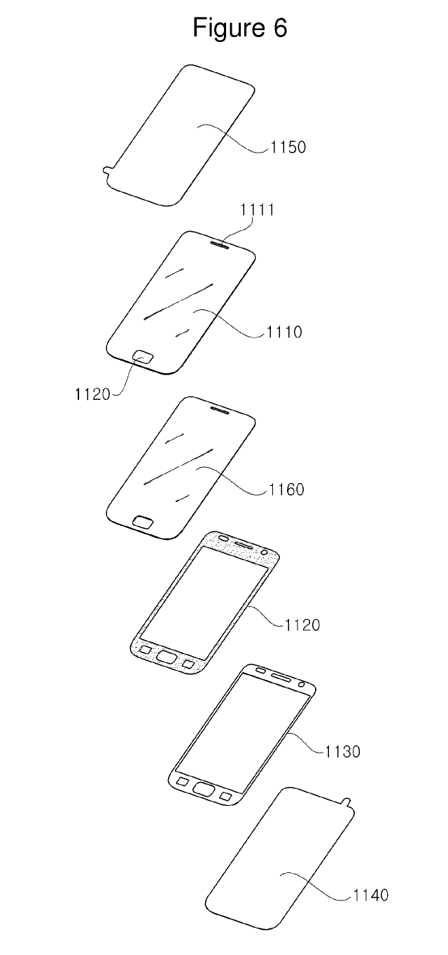

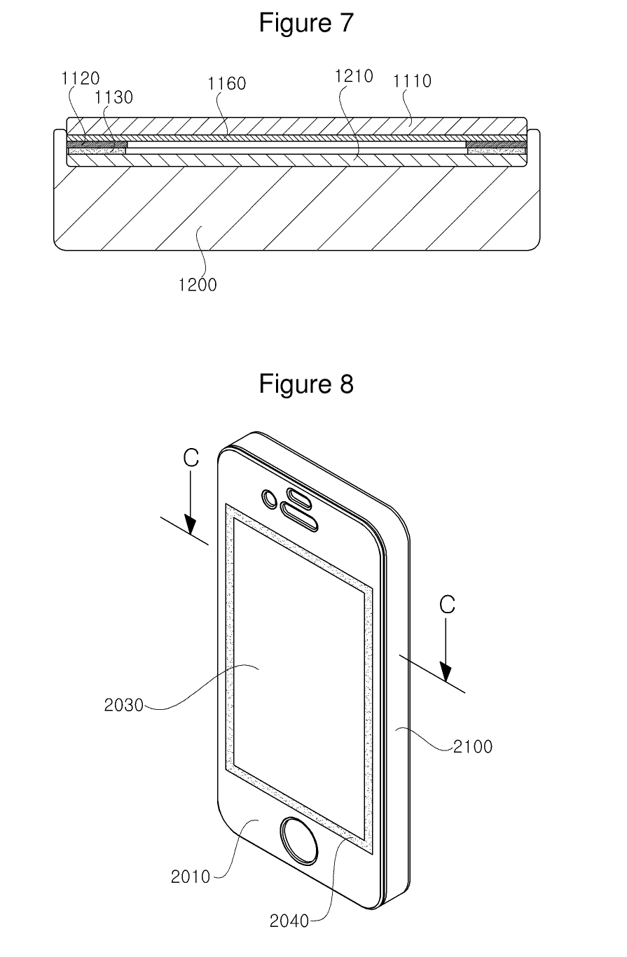

Meanwhile, as shown in FIGS. 6 and 7, the cover 1100 of the present invention may further include a film layer 1160.

FIG. 6 is an exploded perspective view of a liquid crystal protection cover 1100 for a portable terminal according to another first embodiment of the present invention. FIG. 7 is a sectional view of the liquid crystal protection cover 1100 for a portable terminal according to the another first embodiment of the present invention.

The film layer 1160 is formed of a transparent film material, and is attached to an entire lower surface of the transmission protection layer 1110. The film layer 1160 is formed of an uncoated film, and can prevent a rainbow phenomenon generated when the anti-fingerprint coated transmission protection layer 1110 and the display window 1210 contact each other due to a pressing force.

When the film layer 1160 is attached to a lower surface of the transmission protection layer 1110, the pattern layer 1120 is coupled to an area of a lower surface of the film layer 1160 other than an area corresponding to the liquid crystal part 1220 as described above.

A UV paint is applied to an upper surface and/or a lower surface of the film layer 1160 to form a convexo-concave portion (not shown). In this way, more various patterns can be exhibited when light is irradiated to the convexo-concave portion by forming the convexo-concave portion on the upper surface and/or the lower surface of the film layer 1160 with the UV paint.

In the process of forming the convexo-concave portion, if the UV paint is first applied to the film layer 1160 and a roll or a planar metal mask in which a convexo-concave pattern is finely processed presses the UV paint, the convexo-concave portion is formed in the UV paint by the convexo-concave pattern formed in the metal mask. Thereafter, an ultraviolet ray is irradiated to the convexo-concave portion to cure the convexo-concave portion.

Hereinafter, a method of using the present invention will be described.

As shown in FIG. 3, the upper release layer 1150 and the lower release layer 1140 are coupled to the cover 1100 of the present invention when the product is released.

First, after the display window 1210 of the portable terminal 1200 is cleanly wiped, the lower release layer 1140 is separated from the adhesive layer 1130.

The cover 1100 from which the lower release layer 1140 is separated is disposed on the display window 1210 to be fitted well with the display window 1210. That is, a lower surface of the adhesive layer 1130 is coupled to an upper surface of the display window 1210.

Thereafter, the user strongly presses the cover 1100 so that the cover 1100 is coupled well to the display window 1210. Then, the adhesive layer 1130 may be slightly expanded by a pressing force, but since a width of the adhesive layer 1130 is smaller than a width of the pattern layer 1120, the adhesive layer 1130 comes out to the outside of the pattern layer 1120 to be exposed to the outside even when the adhesive layer 1130 is slightly expanded.

After the cover 1100 is coupled to the display window 1210, the upper release layer 1150 is delaminated and separated from the transmission protection layer 1110.

The liquid crystal part 1220 and the display window 1210 of the portable terminal 1200 can be protected by mounting the liquid crystal cover 1100 of the present invention to the portable terminal 1200, and the cover 1100 of the present invention having various colors and patterns can be easily detachably mounted to the portable terminal by the pattern layer 1120 and the convexo-concave portion.

Hereinafter, a second embodiment of the present invention will be described.

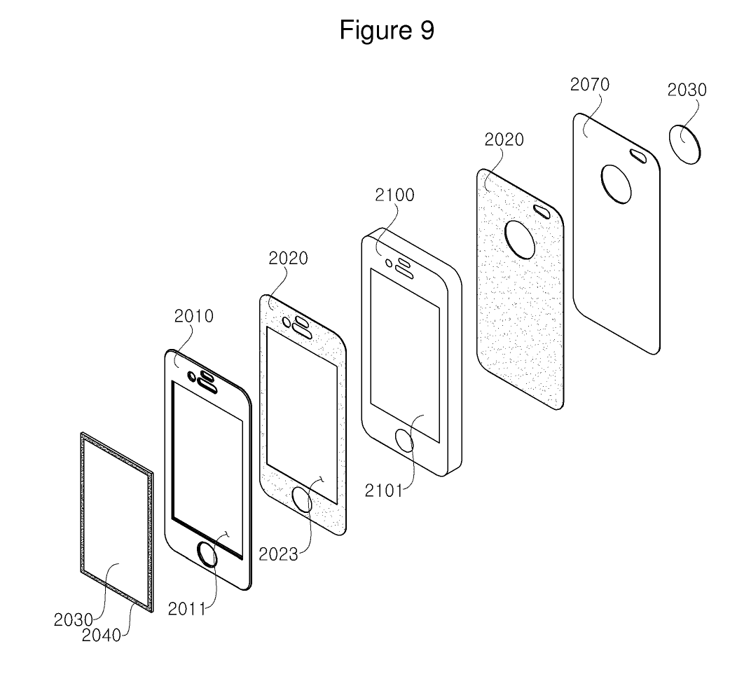

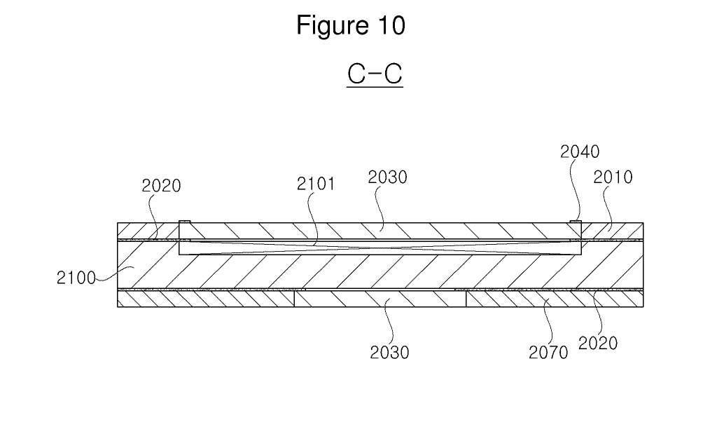

FIG. 8 is a perspective view of a liquid crystal protection cover for a portable terminal according to a second embodiment of the present invention. FIG. 9 is an exploded perspective view of a liquid crystal display cover for a portable terminal according to the second embodiment of the present invention. FIG. 10 is a sectional view taken along line C-C of FIG. 8 according to the second embodiment of the present invention.

The liquid crystal protection cover for a portable terminal according to the second embodiment of the present invention includes a transmission protection layer 2010, a transparent body 2030, and an adhesive layer 2020.

The transmission protection layer 2010 is formed in a plate shape a size of which is the same as or slightly smaller than that of an upper surface of the portable terminal 2100 to be bonded to an upper surface of the portable terminal 2100. A penetration hole 2011 having a size corresponding to a size of the liquid crystal part 2101 formed on an upper surface of the portable terminal 2100 is formed in the transmission protection layer 2010.

The transmission protection layer 2010 may be formed of a metal material to be configured firmly, showing a unique gloss of the metal material. The metal material forming the transmission protection layer 2010 is preferably formed of aluminum which can be easily manufactured, low-priced, and light-weighted. However, the transparent protection layer 2010 may be formed of a synthetic resin, wood, ceramic, and the like as well as a metal material.

The transparent body 2030 is inserted into the penetration hole 2011 of the transmission protection layer 2010 to protect the liquid crystal part 2101 of the portable terminal 2100. A size of the transparent body 2030 is the same or slightly smaller than a size of the penetration hole 2011 of the transmission protection layer 2010, and a thickness of the transparent body 2030 is the same as or slightly smaller than a thickness of the transparent protection layer 2010.

The transparent body 2030 may be formed of a general synthetic resin or a general glass, but is preferably formed of a tempered plastic or a tempered glass to protect the liquid crystal part 2101 of the portable terminal 2100 and prevent a safety accident of a consumer.

The adhesive layer 2020 bonds the transmission protection layer 2010 and the transparent body 2030 to an upper surface of the portable terminal 2100. Various adhesives such as a bond or silicon may be used as the adhesive layer 2020 bonding the transmission protection layer 2010 and the transparent body 2030. However, a tape having a bonding property on opposite side surfaces thereof is preferably used as the adhesive layer 2010 so that the transmission protection layer 2010 and the transparent body 2030 are detachable from the portable terminal 2100.

A lower surface of the transmission protection layer 2010 and a lower surface of the transparent body 2030 are detachably bonded to an upper surface of the portable terminal 2100 by the adhesive layer 2020 formed of one double-sided tape.

A avoidance hole 2023 a size of which is smaller than a size of the transparent body 2030 is formed in the adhesive layer 2020. Although the avoidance hole 2023 of the adhesive layer 2020 is formed to be smaller than the transparent body 2030, it should not cover what is displayed on the liquid crystal part 2101 of the adhesive layer 2100. In this way, since the avoidance hole 2023 of the adhesive layer 2020 is smaller than the transparent body 2030, a lower periphery of the transparent body 2030 inserted through the penetration hole 2011 of the transmission protection layer 2010 is detachably bonded to an upper surface of the portable terminal 2100 by the adhesive layer 2020.

As described above, the transmission protection layer 2010 may be easily replaced by a transmission protection layer 2010 having a different design if necessary by the adhesive layer 2020 formed of a double-sided tape for detachably bonding the transmission protection layer 2010 and the transparent body 2030 to an upper surface of the portable terminal 2100.

The avoidance hole 2023 may not be formed in the adhesive layer 2020, but the lower surface of the transmission protection layer 2010 and the entire lower surface of the transparent body 2030 may be bonded to the upper surface of the portable terminal 2100 such that the transmission protection layer 2010 and the transparent body 2030 are detachable. However, the avoidance hole 2030 is preferably formed in the adhesive layer 2020 such that only a periphery of the transparent body 2030 is attached to the adhesive layer 2020 so that the adhesive layer 2020, to which an entire lower surface of the transparent body 2030 is bonded, is prevented from covering or obstructing what is displayed on the liquid crystal part 2101 of the portable terminal 2100.

Further, as shown in FIG. 10, an opaque strip decoration 2040 is formed at a periphery of the transparent body 2030. The strip decoration 2040 covers an inner portion of the adhesive layer 2020 disposed under the transparent body 2030. In more detail, the strip decoration 2040 is formed at a periphery of the transparent body 2030 so as to cover an inner portion of the adhesive layer 2020 to prevent the adhesive layer 2020 mounted to a periphery of a lower surface of the transparent body 2030 from being exposed to the outside through the transparent body 2030.

The strip decoration 2040 may be formed a lower peripheral surface or an upper peripheral surface of the transparent body 2040. When the strip decoration 2040 is formed on a lower surface of the transparent body 2030, the strip decoration 2040 is attached to and printed on the transparent body 2030 in advance, and is inserted into the penetration hole 2011 to be bonded to the portable terminal 2100 by the adhesive layer 2020.

Further, as shown in FIG. 10, when the strip decoration 2040 is formed at a periphery of an upper surface of the transparent body 2030, a sticker is stuck to or printed on a periphery of an upper surface of the transparent body 2030 bonded to an upper surface of the portable terminal 2100. The strip decoration 2040 formed on an upper surface of the transparent body 2030 may be formed by using a decoration article such as a three-dimensional cubic or a hologram.

When the strip decoration 2040 is formed, a size of the strip decoration 2040 is preferably the same as or larger than a size of an exposed portion of the adhesive layer 2020 exposed to the outside through the transparent body 2030 so that the strip decoration 2040 completely covers an inner surface of the adhesive layer 2020 for bonding the transparent body 2030. The strip decoration 2040 formed in this way decorates the portable terminal 2100 while preventing a portion of the adhesive layer 2020 to which the transparent body 2030, which portion has been modified and whose color has been changed, from being viewed.

Although the transparent body 2030 is inserted into the penetration hole 2011 of the transmission protection layer 2010 and is bonded to an upper surface of the portable terminal 2100 by the adhesive layer 2020 in the second embodiment, only the transmission protection layer 2100 except for the transparent body 2030 may be bonded to an upper surface of the portable terminal 2100 by the adhesive layer 2020 to be used. That is, the liquid crystal part 2101 of the portable terminal 2100 may be exposed to the outside as it is.

Further, as shown in FIGS. 8 and 10, a rear surface protection layer 2070 having a plate shape a size of which is the same as or slightly smaller than that of a rear surface of the portable terminal 2100 may be detachably bonded to a rear surface of the portable terminal 2010, that is, an opposite direction in which the transmission protection layer 210 is disposed, by the adhesive layer 2020. As shown in the figure, a hole is punched in the rear surface protection layer 2070 at a location where a logo or a camera formed on the rear surface of the portable terminal such that the logo or the camera cannot be covered by the rear surface protection layer 2070. As shown in FIG. 10, the transparent body 2030 may be formed at a location of the rear surface protection layer 2070 where the hole is punched to protect the camera and allow the logo to be viewed. The rear surface protection layer 2070 protects the rear surface of the portable terminal 2100 and protects the camera.

As shown in the figures, holes for a signal receiving unit, a signal transmitting unit, proximity sensors, and buttons are punched in the liquid crystal protection cover for a portable terminal according to a type and a characteristic of the portable terminal 2100 so that sounds, sensors, or buttons are prevented from obstructed. All facet corners are rounded to prevent the body of a consumer from being damaged by a sharp facet.

Hereinafter, a third embodiment of the present invention will be described.

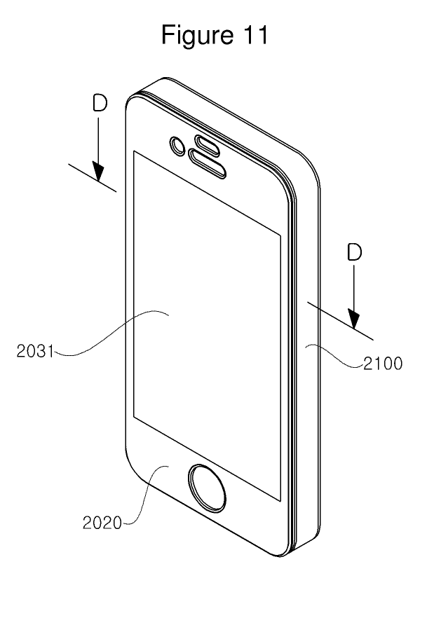

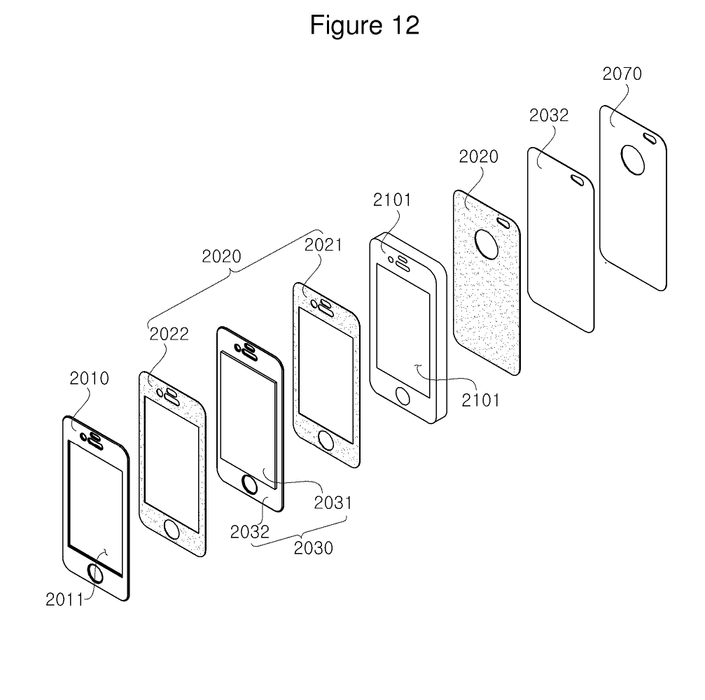

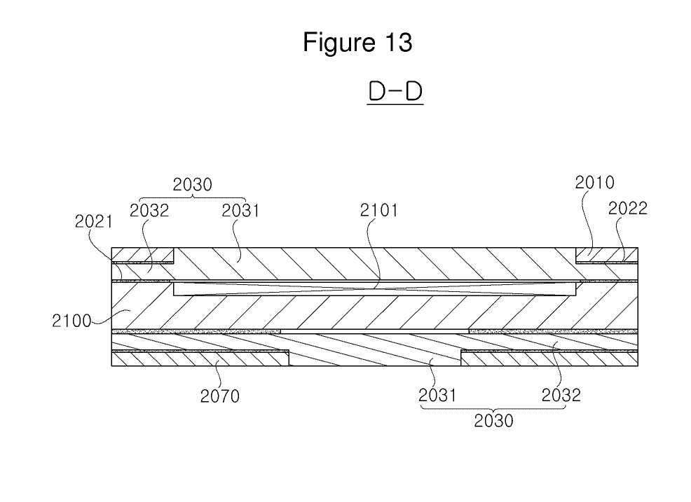

FIG. 11 is a perspective view of a liquid crystal protection cover for a portable terminal according to a third embodiment of the present invention. FIG. 12 is an exploded perspective view of the liquid crystal protection cover for a portable terminal according to the third embodiment of the present invention. FIG. 13 is a sectional view taken along line D-D of FIG. 11 according to the third embodiment of the present invention.

The liquid crystal cover for a portable terminal according to the third embodiment of the present invention includes a transmission protection layer 2010, a transparent body 2030, and an adhesive layer 2020.

The third embodiment differs from the second embodiment in the transparent body 2020, which will be mainly described.

As shown in FIGS. 11 to 13, the transparent body 2030 includes an insertion portion 2031 and a lower end portion 2032.

The insertion portion 2031 is adapted to help view the liquid crystal part 2101 of the portable terminal and has the same shape as that of the penetration hole 2011 to be inserted into the penetration hole 2011. A thickness of the insertion portion 2031 is the same as or slightly smaller than a thickness of the transmission protection layer 2010.

As shown in FIG. 13, the lower end portion 2032 is formed at a lower portion of the insertion portion 2031 and has a size larger than that of the insertion portion 2031. A step is formed at an upper periphery of the lower end portion 2032 and has a size slightly smaller than or the same size as an upper surface of the portable terminal.

The transmission protection layer 2010 is positioned on the step formed by the lower end portion 2032 and the insertion portion 2031 of the transparent body 2030.

As shown in FIG. 13, the adhesive layer 2020 bonding the transparent body 2030 and the transmission protection layer 2010 to the portable terminal 2100 includes a first adhesive layer 2021 and a second adhesive layer 2022.

The first adhesive layer 2021 detachably bonds a lower surface of the lower end portion 2032 to the portable terminal 2100.

The second adhesive layer 2022 detachably bonds the transmission protection layer 2010 to a step of an upper periphery formed by the insertion portion 2031 and the lower end portion 2032 of the transparent body 2030.

The first adhesive layer 2021 bonding a lower surface of the lower end portion 2032 of the transparent body 2030 to the portable terminal 2100 may detachably bond an entire lower surface of the lower portion 2032 of the transparent body 2030 to the portable terminal 2100.

However, as shown in FIG. 13, a hole having a size the same as or larger than that of a lower surface of the transmission protection layer 2010 positioned on a periphery of an upper surface of the lower end portion 2032 is formed in the first adhesive layer 2021 so that the first adhesive layer 2021 is detachable.

In the third embodiment, the transparent body 2030 is formed of a tempered plastic or a tempered glass, and is preferably formed of a tempered plastic to help easily process the insertion portion 2031. However, if necessary, after being manufactured of a tempered plastic or a tempered glass, the lower end portion 2032 and the insertion portion 2031 may be integrally bonded to each other to form the transparent body 2030.

Further, even in the third embodiment, the rear surface protection layer 2070 may be detachably coupled to a rear surface of the portable terminal 2100.

In the third embodiment, since the adhesive layer 2020 is not exposed to the outside through the transparent body 2030, the strip decoration 2040 of the second embodiment is unnecessary.

The remaining configurations other than the transparent body 2030 and the strip decoration 2040 are the same as those of the second embodiment, and a detailed description thereof will be omitted.

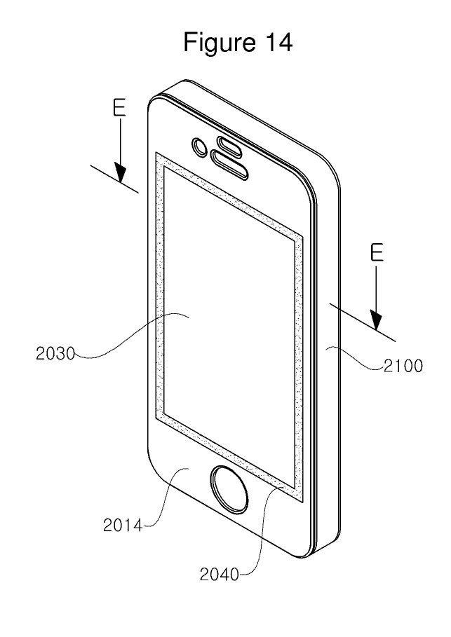

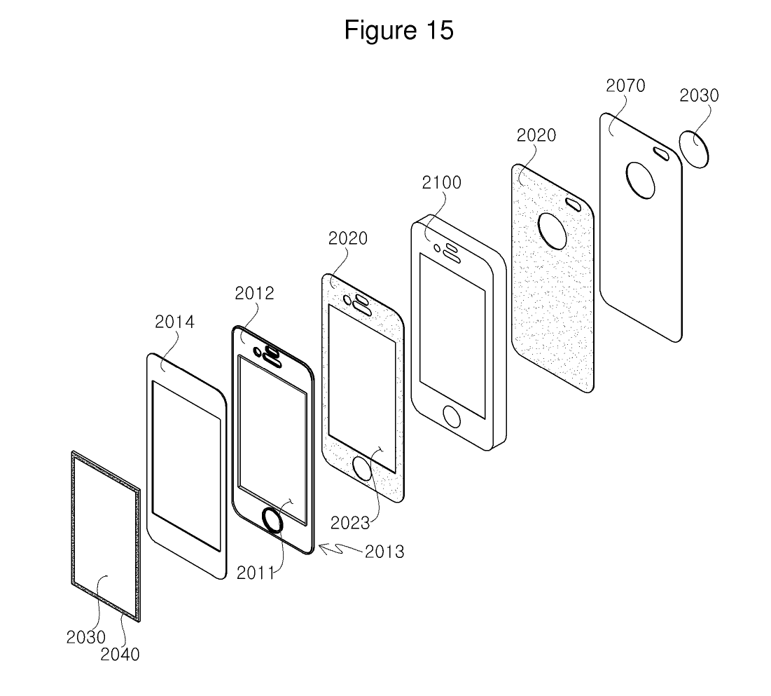

FIG. 14 is a perspective view of a liquid crystal protection cover for a portable terminal according to a fourth embodiment of the present invention. FIG. 15 is an exploded perspective view of the liquid crystal protection cover according to the fourth embodiment of the present invention.

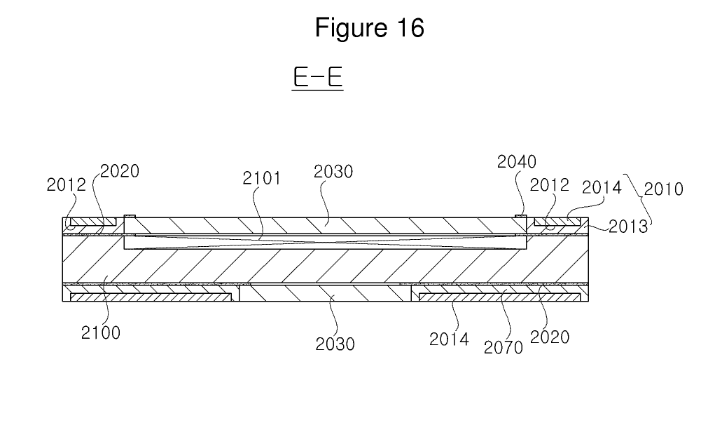

FIG. 16 is a sectional view taken along line E-E of FIG. 14 according to the fourth embodiment of the present invention.

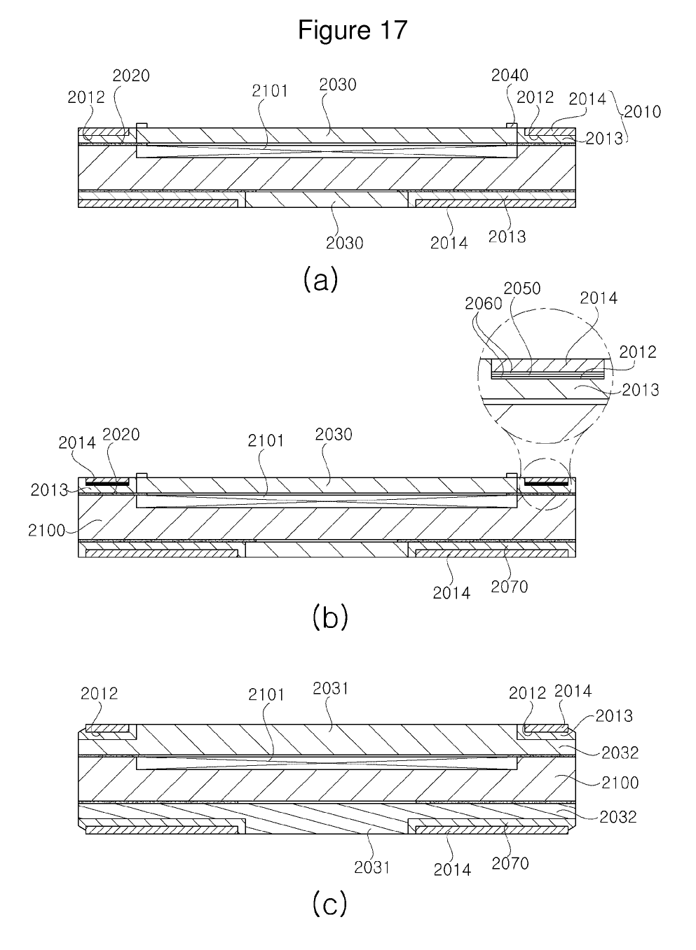

FIG. 17 is a sectional view showing another structure of a transmission according to the fourth embodiment of the present invention.

The liquid crystal cover for a portable terminal according to the fourth embodiment of the present invention includes a transmission protection layer 2010, a transparent body 2030, and an adhesive layer 2020.

The fourth embodiment differs from the second embodiment and the third embodiment in the transmission protection layer 2010, which will be mainly described.

FIG. 17A is a sectional view showing that an upper portion and an outer surface of a recess 2012 of the transmission protection layer 2010 are opened, FIG. 17B are sectional view showing a structure in which a decoration portion 2014 is detachably mounted to the recess 2012 by a magnet 2050, and FIG. 17C is a sectional view showing that an outer portion of a support portion 2013 forming the recess 2012 are inclinedly formed.

As shown in FIGS. 14 to 16, the transmission protection layer 2010 includes a support portion 2013 and a decoration portion 2014.

The recess 2012 is formed on an upper surface of the support portion 2013. The recess 2012 is opened upward as shown in FIG. 16, or an outer surface and an upper portion of the recess 2012 are opened as in FIG. 17A.

The decoration portion 2014 is inserted and mounted into the support portion 2013 forming the recess 2012 to allow the transmission protection layer 2010 to decorate the portable terminal.

The decoration portion 2014 is formed of wood, cloth, a film, a synthetic resin material, a metal material, and leather, and is inserted and coupled into the recess 2012 by a bond, a double-sided tape, a magnet 2050, and the like.

When the magnet 2050 is used to couple the decoration portion 2014 to the support portion 2013, if the transmission protection layer 2010 and the decoration portion 2014 are magnetic bodies, the magnet 2050 is disposed between an inner surface of the recess 2012 of the transmission protection layer 2010 and a contact surface of the decoration portion 2014 such that the inner surface of the recess 2012 of the transmission protection layer 2010 and the contact surface of the decoration portion 2014 are detachable. However, when any one of the transmission protection layer 2010 and the decoration portion 2014 is a nonmagnetic body, a thin steel plate 2060 is integrally bonded to the decoration portion 2014 which is a nonmagnetic body or a mounting surface of the recess 2012 as shown in FIG. 17B.

Further, when the magnet 2050 is disposed between an inner surface of the recess 2012 of the transmission protection layer 2010 and the steel plate 2060 integrally bonded to the mounting surface of the decoration portion 2014, the magnet 2050 is bonded to the steel plate 2060 to allow the decoration portion 2014 to be detachably coupled to the recess 2012 of the support portion 2013. If the decoration portion 2014 is detachably attached, a color and a material of the decoration portion 2014 may be selected according to a taste of a consumer.

Further, as shown in FIG. 17C, a step may be formed by making a height of an outer side of the support portion 2013 forming the recess 2012 in the transmission protection layer 2010 lower than a height of the decoration portion 2014 inserted and mounted into the recess 2012.

In FIG. 17C, an outer portion of the support portion 2013 forming the recesses 2012 is formed to be inclined downward toward the outside. In this way, by making a height of an outer side of the support portion 2013 forming the recess 2012 lower than a height of the decoration portion 2014, not only an upper surface but also a side surface of the decoration portion 2014 are exposed to the outside by the step of the support portion 2013 and the decoration portion 2014 to allow the user to feel a new aesthetic feeling and a touch feeling.

Meanwhile, the transparent body 2030 may be the transparent body of the second embodiment having no step as shown in FIGS. 17A and 17B, and may be the transparent body of the third embodiment having a step as shown in FIG. 17C.

Further, as in the second embodiment and the third embodiment, the rear surface protection layer 2070 and the transparent body 2030 may be mounted to the rear surface of the portable terminal 2100. Then, the rear surface protection layer 2070 may be the same as one of the transmission protection layers 2010 shown in the second embodiment and the third embodiment. FIGS. 16 and 17 shows that the rear surface protection layer 2070 has the same structure as that of the transmission protection layer 2010 of the third embodiment.

The remaining configurations except for the transmission protection layer are the same in the second embodiment and the third embodiment, and a detailed description thereof will be omitted.

In this way, the liquid crystal cover for a portable terminal of the present invention can decorate the same portable terminal as a portable terminal 2100 having a unique design satisfying a taste of the consumer while giving life to the unique features of the shape of the portable terminal 2100, protect the liquid crystal part 2101 easily damaged by an external impact, and protect a surface of the liquid crystal part 2101 from being flawed. Further, the elements may be replaced according to a request of the user while realizing various colors and various materials.

Hereinafter, a fifth embodiment of the present invention will be described.

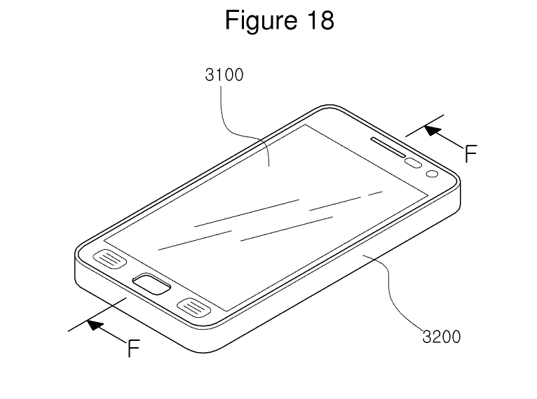

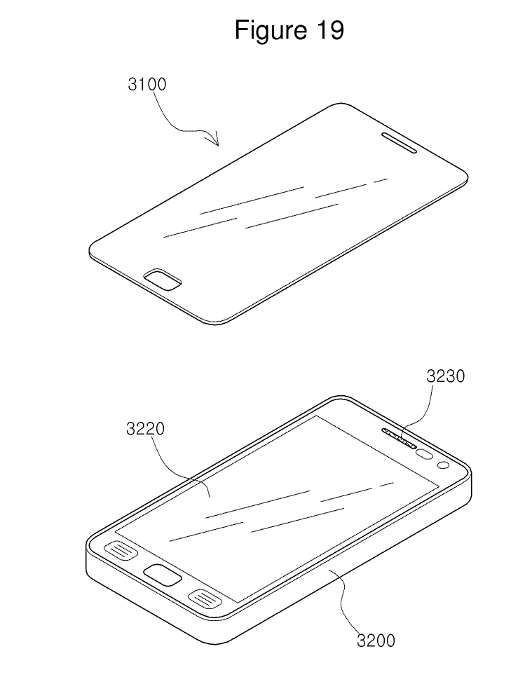

FIG. 18 is a perspective view showing a state in which a liquid crystal protection cover for a portable terminal according to a fifth embodiment of the present invention is coupled to a portable terminal. FIG. 19 is a perspective view showing a state in which the liquid crystal protection cover for a portable terminal according to the fifth embodiment of the present invention is separated from the portable terminal.

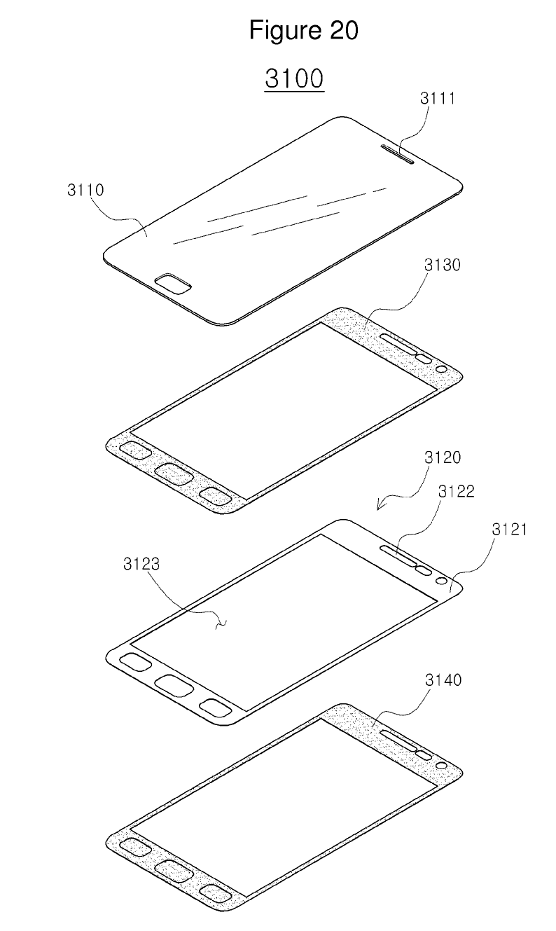

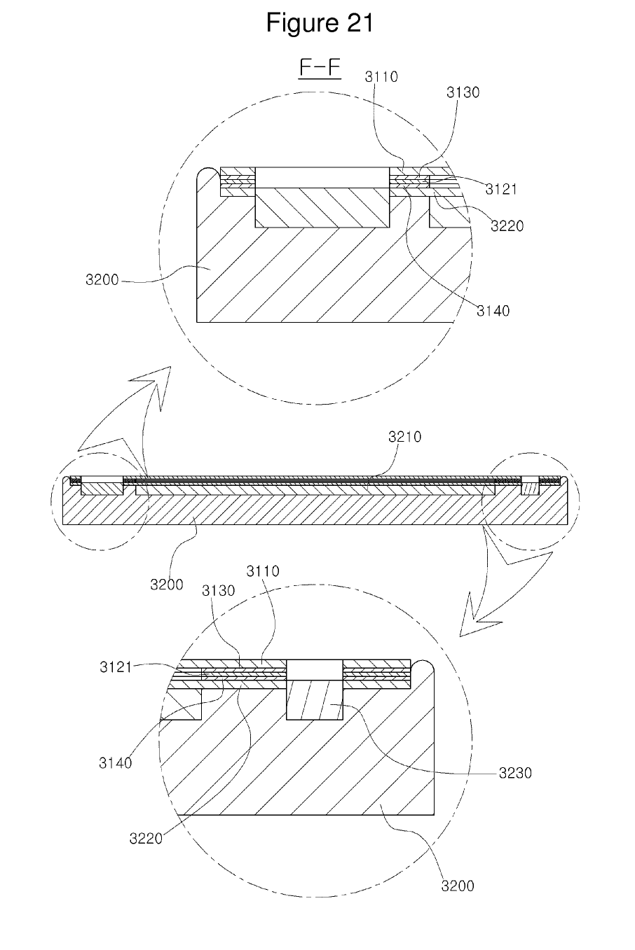

FIG. 20 is an exploded perspective view of the liquid crystal protection cover for a portable terminal according to the fifth embodiment of the present invention. FIG. 21 is a sectional view taken along line F-F of FIG. 18 according to the fifth embodiment.

As shown in FIGS. 18 and 19, the liquid crystal protection cover 3100 for a portable terminal of the present invention is coupled to an upper surface of a portable terminal 3200 having a liquid crystal part 3210 such as an LCD at an upper portion thereof and in which a display window 3220 covering an upper portion of the liquid crystal part 3210 is mounted to an upper surface thereof to protect the liquid crystal part 3210 and the display window 3220.

As shown in FIGS. 20 and 21, the liquid crystal protection cover 3100 for a portable terminal includes a transmission protection layer 3110, a shielding member 3120, and an adhesive layer.

The transmission protection layer 3110 is formed of a tempered glass, a tempered plastic, or a synthetic resin film, and is disposed on the display window 3220. A second through-hole 3111 is formed at a location of the transmission protection layer 3110 corresponding to a speaker 3230 of the portable terminal 3200.

The shielding member 3120 functions to interrupt or absorb electronic waves generated in the portable terminal 3200, and is coupled to a lower surface of the transmission protection layer 3110 or an upper surface of the display window 3220.

In the embodiment, the shielding member 3120 is formed of a flat plate-shaped shielding sheet 3121, and is disposed between the transmission protection layer 3110 and the display window 3220 to cover an upper surface of the display window 3220 other than the liquid crystal part. That is, an entire size of the shielding sheet 3121 in the embodiment is substantially the same as a size of the transmission protection layer 3110, and a first penetration hole 3123 having a size corresponding to that of the liquid crystal part 3210 is formed at a central portion of the shielding sheet 3121.

Thus, an image of the liquid crystal part 3210 is exposed to the outside through the first penetration hole 3123 of the shielding sheet 3121.

The shielding sheet 3121 is disposed between a lower surface of the transmission protection layer 3110 and an upper surface of the display window 3220 to interrupt or absorb electronic waves generated in the portable terminal 3200.

Detailed substances and materials of the shielding sheet 3121 may be known ones according to the related art, and a detailed description thereof will be omitted.

The first through-hole 3122 is formed at a location of the shielding sheet 3121 corresponding to the speaker 3230 of the portable terminal, and the first through-hole 3122 has the same size as that of the second through-hole 3111 and is communicated with the second through-hole 3111.

Further, a pattern layer (not shown) having a size the same as or larger than that of the shielding sheet 3121 is preferably applied to a lower surface of the transmission protection layer 3110 to conceal the shielding sheet 3121 from the outside.

Since the shielding sheet 3121 is coupled not to a lower surface of the portable terminal 3200 but an upper surface of the portable terminal 3200, that is, the transmission protection layer 3110, electronic waves can be interrupted from propagated toward the transmission protection layer 3110 contacting the face of the user or can be absorbed during a voice communication of the portable terminal 3200.

The adhesive layer bonds the transmission protection layer 3110 to an upper surface of the portable terminal 3200, and includes a first adhesive portion 3130 and a second adhesive portion 3140.

The first adhesive portion 3130 functions to couple the transmission protection layer 3110 and the shielding sheet 3121, and the second adhesive portion 3140 functions to detachably couple the shielding sheet 3121 to an upper surface of the display window 3220. In this way, since the second adhesive portion 3140 detachably couple the shielding sheet 3121 to an upper surface of the display window 3220, the liquid crystal cover 3100 of the present invention can be replaced by one having various patterns according to a taste of the user.

Further, a bonding force of the first adhesive portion 3130 is stronger than a bonding force of the second adhesive portion 3140. This is because the transmission protection layer 3110 and the shielding sheet 3121 can be prevented from being separated first when the liquid crystal protection cover 3100 of the present invention is separated from the portable terminal 3200.

Further, the first bonding portion 3130 and the second bonding portion 3140 may be adhesives or double-sided tapes having different bonding properties.

Although it is illustrated in the drawings that the first adhesive portion 3130 and the second adhesive portion 3140 have sheet shapes to express them better, the present invention is not limited thereto.

The second adhesive portion 3140 is preferably formed of a tape opposite surfaces of which have a bonding property such that a bonding force of a surface contacting the shielding sheet 3121 is stronger than a bonding force of a surface contacting the display window 3220. Accordingly, when the liquid crystal protection cover 3100 of the present invention is separated from the portable terminal 3200, the second adhesive portion 3140 is coupled to a lower surface of the shielding sheet 3121 without being attached to the display window 3220 of the portable terminal 3200.

In this way, the transmission protection layer 3110 is coupled to the display window 3220 by the first adhesive portion 3130 and the second adhesive portion 3140 through the shielding sheet 3121.

By mounting the liquid crystal protection cover 3100 for a portable terminal of the present invention, the liquid crystal part 3210 and the display window 3220 of the portable terminal 3220 can be protected and the liquid crystal protection cover 3100 having various patterns can be easily detachably mounted to the portable terminal 3200 according to a taste of the user. In addition, by interrupting electronic waves generated in the portable terminal 3200 by the shielding sheet 3121, a harmful effect of electronic waves generated by the portable terminal 3200 can be minimized. In particular, since the shielding sheet 3121 is coupled to the transmission protection layer 3110 contacting a face during a voice communication, electronic waves can be prevented from being directly transferred to the head of the user.

Hereinafter, a sixth embodiment of the present invention will be described.

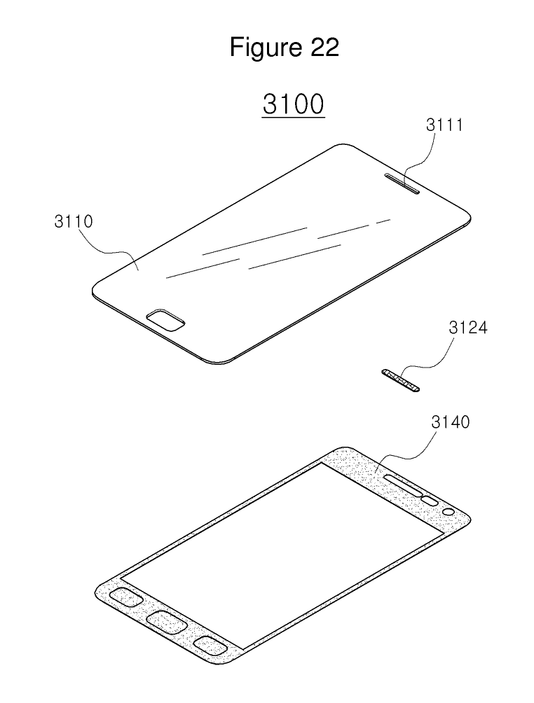

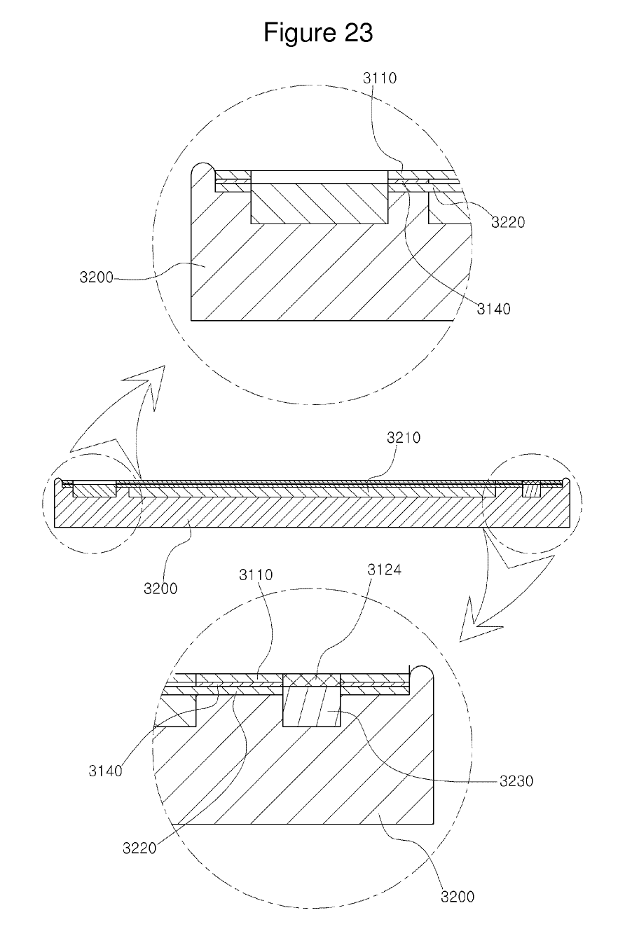

FIG. 22 is an exploded perspective view of a liquid crystal protection cover 3100 according to a sixth embodiment of the present invention. FIG. 23 is a sectional view showing a state in which the liquid crystal protection cover 3100 according to the sixth embodiment of the present invention is mounted to a portable terminal.

As shown in FIGS. 22 and 23, the liquid crystal protection cover according to the sixth embodiment includes a transmission protection cover 3110, a shielding member, and a second adhesive portion 3140.

The sixth embodiment is the same as or similar to the fifth embodiment in the transmission protection layer 3110 and the second adhesive portion 3140, but differs from the fifth embodiment in the shielding member and the shielding member will be mainly described.

In the embodiment, the shielding member includes a shielding net 3124 formed of a conductive material.

The shielding net 3124 is coupled to the display window 3220 while covering the speaker 3230 of the portable terminal, and a second through-hole 3111 into which the shielding net 3124 is inserted is formed in the transmission protection layer 3110. The shielding net 3124 is formed of a metal material or a conductive synthetic resin material. Further, the shielding net 3124 is coupled to the display window 3220 or the transmission protection layer 3110 by a separate adhesive.

The second adhesive portion 3140 functions to couple the transmission protection layer 3110 to the display window 3220, and is formed of a double-sided tape or an adhesive. Of course, the transmission protection layer 3110 and the shielding net 3124 may be coupled to the display window 3220 through the second adhesive portion 3140.

In this way, since the shielding net 3124 is formed of a conductive material instead of plastic, electronic waves propagating through the speaker 3230 can be interrupted and/or absorbed by the shielding net 3124.

In particular, during a voice communication through the portable terminal 3220, since electronic waves emitted through the speaker disposed closest to the head of the user can be more effectively interrupted by the shielding net 3124, a harmful effect due to the electronic waves generated during the use of the portable terminal 3200 can be minimized.

Hereinafter, a seventh embodiment of the present invention will be described.

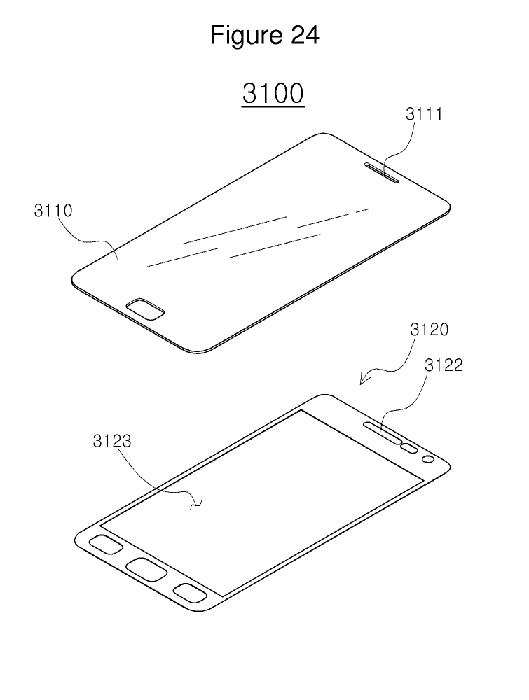

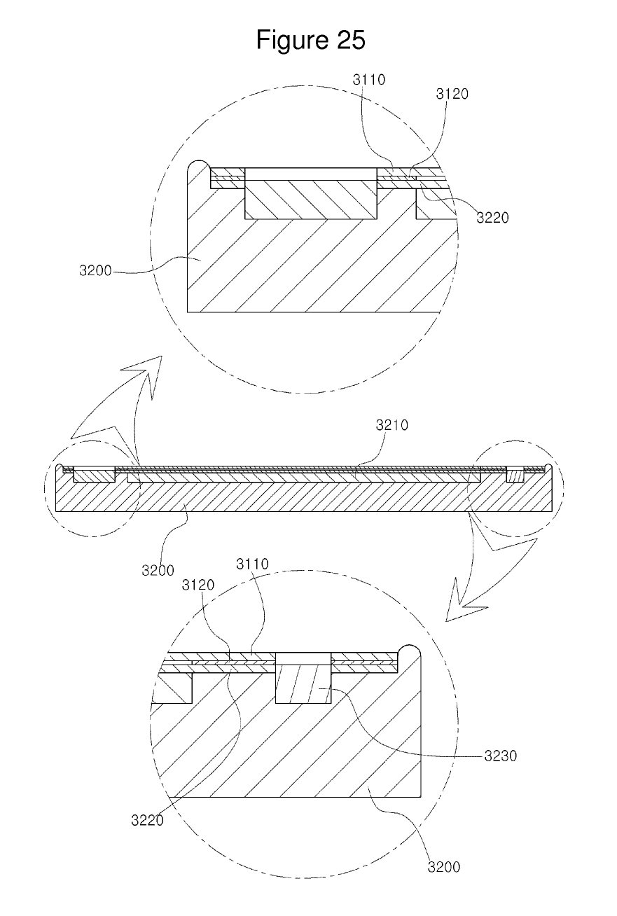

FIG. 24 is an exploded perspective view of a liquid crystal protection cover 3100 for a portable terminal according a seventh embodiment of the present invention. FIG. 25 is a sectional view showing a state in which the liquid crystal protection cover 3100 for a portable terminal according the seventh embodiment of the present invention.

As shown in FIGS. 24 and 25, the liquid crystal protection cover according to the seventh embodiment includes a transmission protection cover 3110 and a shielding member 3120.

The seventh embodiment is the same as or similar to the fifth embodiment in the transmission protection layer 3110, but differs from the fifth embodiment in the shielding member and the shielding member will be mainly described.

In the embodiment, the shielding member 3120 functions to interrupt or absorb electronic waves as in the above-described fifth embodiment.

The shielding member 3120 itself has a bonding property unlike the fifth embodiment to couple the transmission protection layer 3110 to the display window 3220. That is, when compared with the fifth embodiment, the shielding member 3120 does not have a separate configuration from the adhesive layer but has the same configuration.

The shielding member 3120 may be formed by applying a conductive material to the double-sided tape, or may be formed by containing a conductive material in an adhesive.

Then, a pattern layer (not shown) having various patterns and colors is printed on a lower surface of the transmission protection layer 3110, and the shielding member 3120 is disposed under the transmission protection layer 3110. It is because the shielding member 3120 mostly has an achromatic color, and the liquid crystal protection cover having various colors and patterns can be manufactured by disposing the shielding member 3120 under the pattern layer.

In this way, by providing the shielding member itself with a bonding property, the transmission protection layer 3110 can be more easily coupled to the display window 3220 of the portable terminal by making the liquid protection cover 3100 thin.

The other operations and effects of the seventh embodiment are the same as the fifth embodiment, and a detailed description thereof will be omitted.

Hereinafter, an eighth embodiment of the present invention will be described.

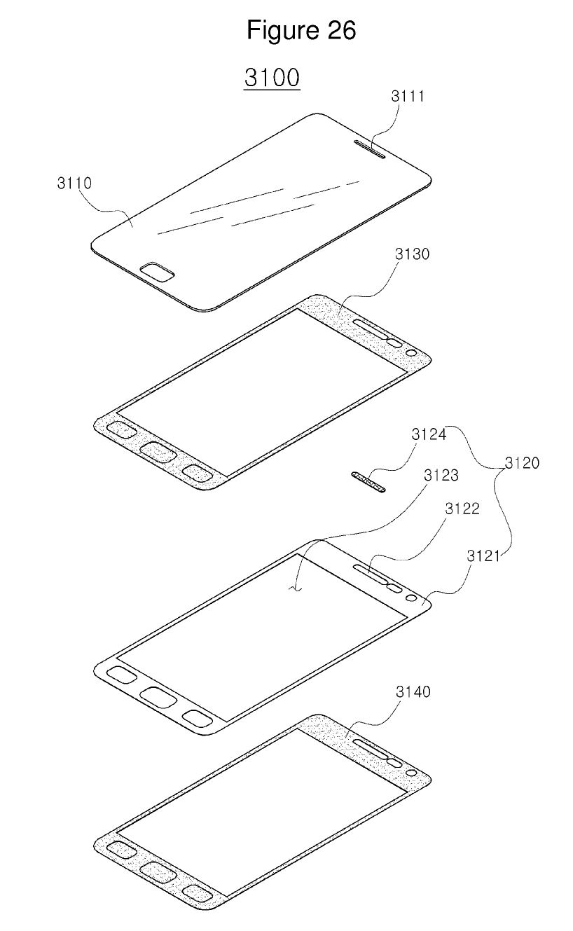

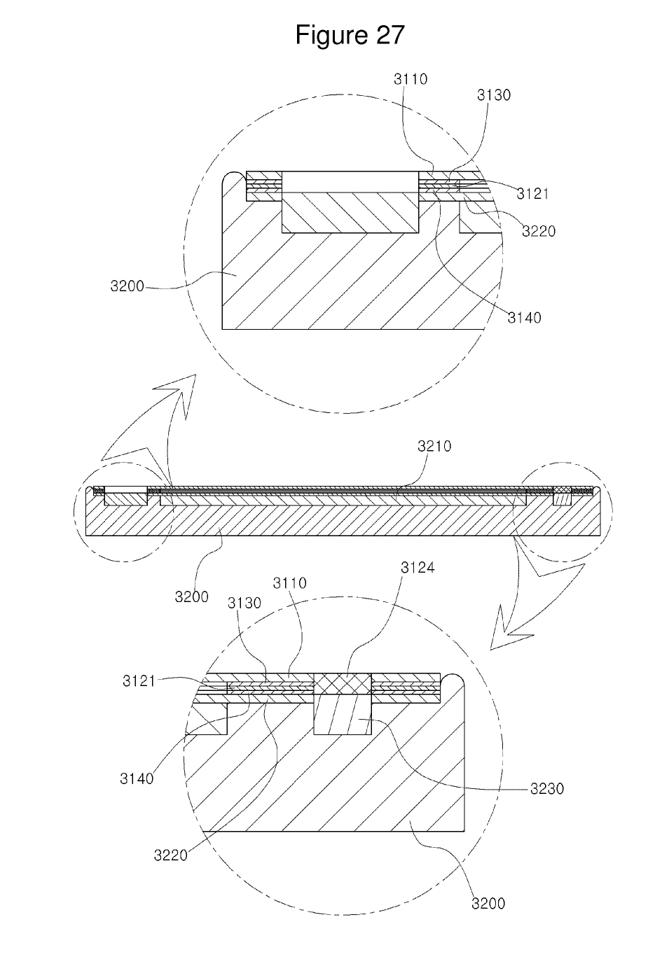

FIG. 26 is an exploded perspective view of a liquid crystal protection cover 3100 for a portable terminal according an eighth embodiment of the present invention. FIG. 27 is a sectional view showing a state in which the liquid crystal protection cover 3100 for a portable terminal according the eighth embodiment of the present invention.

As shown in FIGS. 26 and 27, the liquid crystal protection cover according the eighth embodiment includes a transmission protection layer 3110, a shielding member 3120, a first adhesive portion 3130, and a second adhesive portion 3140.

The eighth embodiment is the same as or similar to the fifth embodiment in the transmission protection layer 3110, the first adhesive portion 3130, and the second adhesive portion 3140 but differs from the fifth embodiment in the shielding member 3120 and the shielding member 3120 will be mainly described.

The shielding member 3120 includes a shielding sheet 3121 disposed between the transmission protection layer 3110 and the display window 3220 to cover an upper surface of the display window 3220 other than the liquid crystal part, and a conductive shielding net 3124 coupled to the display window 3220 while covering a speaker 3230 of the portable terminal.

The shielding sheet 3121 is the same as the shielding sheet of the fifth embodiment and the shielding net 3124 is the same as the shielding net of the sixth embodiment, and a detailed description thereof will be omitted.

Further, the transmission protection layer 3110 is coupled to the display window 3220 while covering the shielding sheet 3121. Then, the first adhesive portion 3130 coupled the transmission protection layer 3110 and the shielding sheet 3121, and the second adhesive portion 3140 couples the shielding sheet 3121 to the display window 3220.

A first through-hole 3122 into which the shielding net 3124 is inserted is formed in the shielding sheet 3121, and a second through-hole 3111 into which the shielding net 3124 is inserted is formed in the transmission protection layer 3110.

In this way, both the shielding sheet 3121 and the shielding net 3124 are mounted, electronic waves generated in the portable terminal 3200 can be further interrupted.

The other operations and effects are the same as or similar to the fifth to seventh embodiments, and a detailed description thereof will be omitted.

Hereinafter, a ninth embodiment of the present invention will be described.

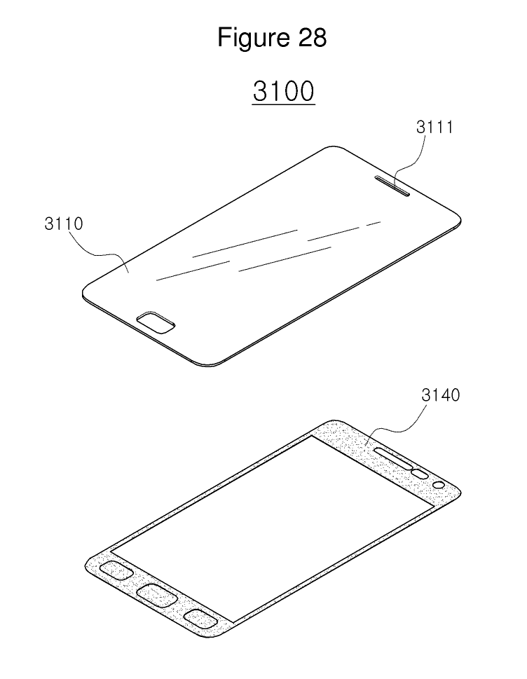

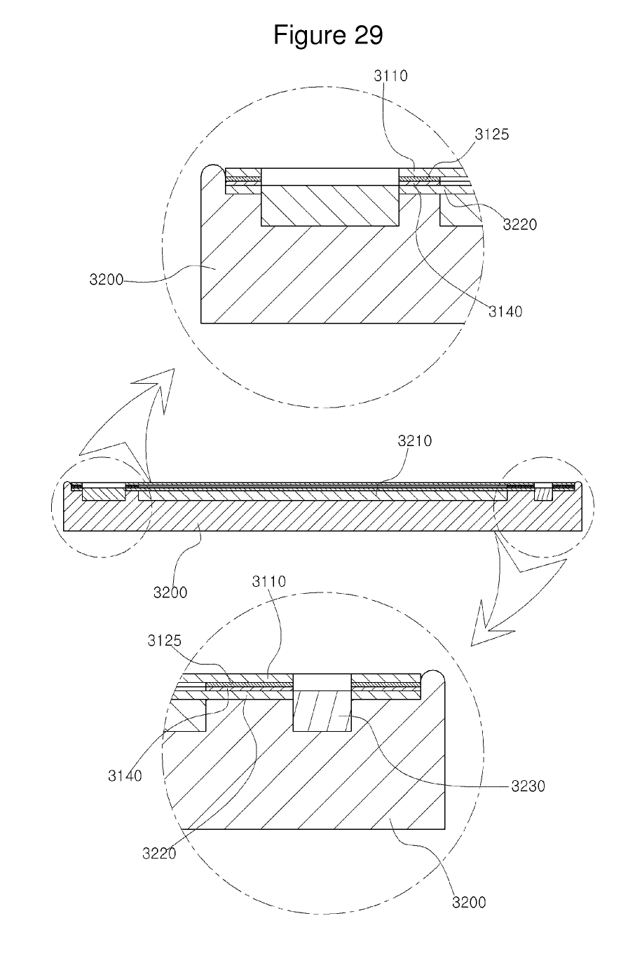

FIG. 28 is an exploded perspective view of a liquid crystal protection cover 3100 for a portable terminal according a ninth embodiment of the present invention. FIG. 29 is a sectional view showing a state in which the liquid crystal protection cover 3100 for a portable terminal according the ninth embodiment of the present invention.

As shown in FIGS. 28 and 29, the liquid crystal protection cover according to the ninth embodiment includes a transmission protection layer 3110, a shielding member, and a second adhesive portion 3140.

The ninth embodiment is the same as or similar to the fifth embodiment in the transmission protection layer 3110 and the second adhesive portion 3140, but differs from the fifth embodiment in the shielding member and the shielding member will be mainly described.

In the embodiment, the shielding member includes a conductive ink layer 3125 applied to a lower surface of the transmission protection layer 3110 to interrupt or absorb electronic waves.

A lower surface of the conductive ink layer 3125 applied to a lower surface of the transmission protection layer 3110 is coupled to an upper surface of the display window 3220 by the second adhesive portion 3140 to couple the liquid crystal protection cover 3100 to the display window 3220.

Then, it is preferable that a pattern layer (not shown) having various patterns and colors is first printed on a lower surface of the transmission protection layer 3110 and the conductive ink layer 3125 is applied to a lower surface of the pattern layer. Of course, in the embodiment, separately from the conductive ink layer 3125, the shielding net mentioned in the sixth embodiment may be mounted to the display window 3220 to cover the speaker 3230.

The other operations and effects are the same as the fifth to eighth embodiments, and a detailed description thereof will be omitted.

Hereinafter, a tenth embodiment of the present invention will be described.

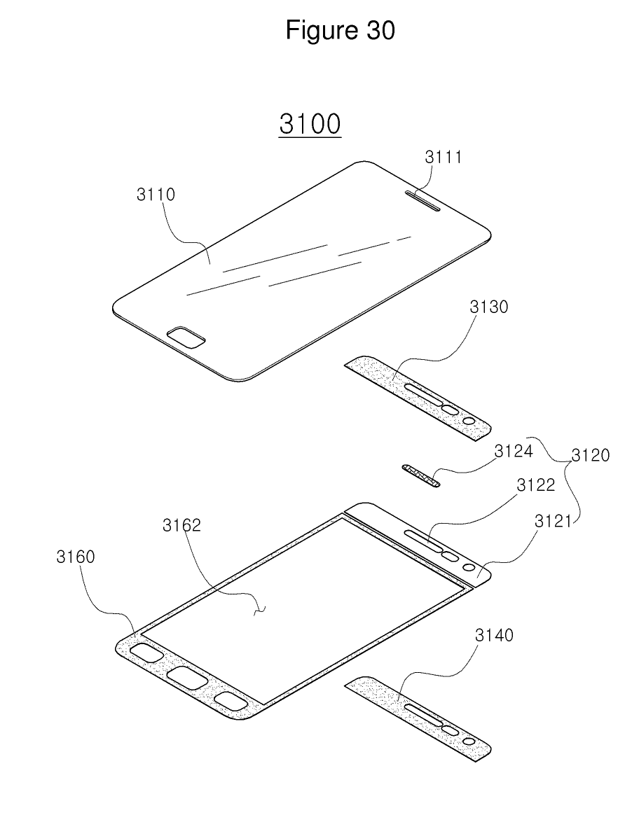

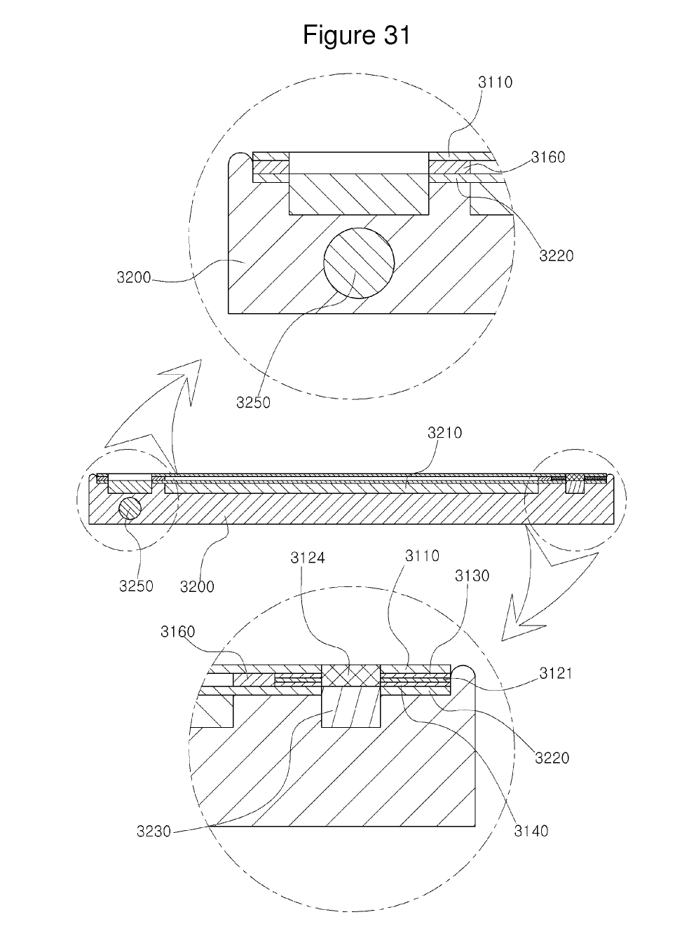

FIG. 30 is an exploded perspective view of a liquid crystal protection cover for a portable terminal according a tenth embodiment of the present invention. FIG. 31 is a sectional view showing a state in which the liquid crystal protection cover for a portable terminal according the tenth embodiment of the present invention.

As shown in FIGS. 30 and 31, the liquid crystal protection cover 3100 for a portable terminal according to the tenth embodiment includes a transmission protection layer 3110, a shielding member 3120, a first adhesive portion 3130, a second adhesive portion 3140, and a double-sided adhesive sheet 3160.

The tenth embodiment differs from the fifth embodiment in the shielding member 3120 and the double-sided adhesive sheet 3160, and the shielding member 3120 and the double-sided adhesive sheet 3160 will be mainly described.

The shielding member 3120 may include a shielding sheet 3121, a conductive ink layer 3125, and a shielding net 3124 which have been described in the above embodiments.

Although it is illustrated in FIGS. 30 and 31 that the shielding member 3120 includes the shielding sheet 3121 and the shielding net 3124, but the present invention is not limited thereto.

Unlike the fifth embodiment, the shielding sheet 3121 constituting the shielding member 3120 is smaller than the transmission protection layer 3110 to be coupled to a portion of the transmission protection layer 3110.

In the embodiment, the shielding sheet 3121 is coupled only to an upper end of a lower surface of the transmission protection layer 3110. Further, a lower surface of the shielding sheet 3121 facing the portable terminal 3200 is coupled to the display window 3220 of the portable terminal 3200 by the second adhesive portion 3140.

Further, the shielding net 3124 is coupled to an upper surface of the display window 3220 at a location adjacent to the shielding sheet 3121 while covering a speaker 3230 of the portable terminal.

The double-sided adhesive sheet 3160 has a flat plate shape, and is coupled to a lower surface of the transmission protection layer 3110 to couple the transmission protection layer 3110 to the display window 3220.

A second penetration hole 3162 is formed in the double-sided adhesive sheet 3160. That is, the second penetration hole 3162 having a size corresponding to the liquid crystal part 3210 is formed in the double-sided adhesive sheet 3160.

The double-sided adhesive sheet 3160 is disposed adjacent to the shielding member 3120 horizontally. Further, a thickness of the double-sided adhesive sheet 3160 is the same as or slightly larger than a thickness of the shielding member 3120. Preferably, a thickness of the double-sided adhesive sheet 3160 is substantially the same as a total sum of the thicknesses of the shielding member 3120, the first adhesive portion 3130, and the second adhesive portion 3140, so that when the liquid crystal protection cover 3100 is mounted to the portable terminal 3200, one side of the transmission protection layer 3110 can be prevented from getting loose.

Further, the shielding member 3120 coupled not to the entire transmission protection layer 3110 but to a portion of the transmission protection layer 3110 is disposed on a side opposite to a side of the display window 3220 where an antenna 3250 of the portable terminal 3200 is disposed. That is, the shielding member 3120 is disposed to be distant from the antenna 3250 of the portable terminal 3200.

The speaker 3230 of the portable terminal is generally formed at an upper end portion of the portable terminal 3200 and the antenna 3250 is formed at a lower end portion of the portable terminal 3200, in which case the shielding member 3120 is disposed at an upper portion of the portable terminal 3200 distant from the antenna 3250 to be disposed at a portion of the speaker 3230. Accordingly, since the shielding member 3120 is coupled around the speaker 3230 closest to the head of the user during a voice communication of the portable terminal 3200, electronic waves propagating through the speaker 3230 can be better interrupted from being transferred to the human body.

Further, since the shielding member 3120 is distant from the antenna 3250, a reception rate of the antenna 3250 can be prevented from being lowered by the shielding member 3120.

The other configurations, operations, and effects are the same as or similar to the above embodiments, and a detailed description thereof will be omitted.

Hereinafter, an eleventh embodiment of the present invention will be described.

The eleventh embodiment relates to the transmission protection layer mentioned in the first to tenth embodiments.

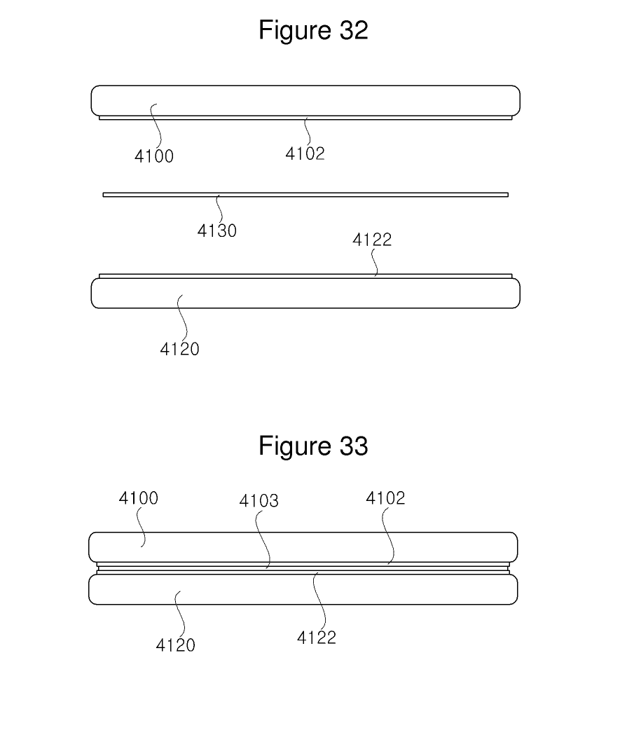

FIGS. 32 and 33, the transmission protection layer of the embodiment includes a first film 4100; a second film 4120 facing the first film 4100 and bonded to a tempered glass of the portable terminal; an information printing layer 4130 inserted between the first film 4100 and the second film 4120; and a glue layer applied between the first film 4100 and the second film 4120 to bond the first film 4100 and the second film 4120 to each other, for closing the information printing layer 4130.

Since the first film 4100 is manufactured of a synthetic resin sheet of a PET material and an upper surface of the first film is exposed to the outside, a hardness of the surface is increased by using a hardener, to prevent a scratch from being generated or worn out.

Further, since the second film 4120 is manufactured of a synthetic resin sheet of a PET material and should be bonded to the display window of the portable terminal formed of a tempered glass, it should have a soft property. A bottom surface of the second film 4120 is adsorbed to an upper surface of the tempered glass of the portable terminal due to a surface tension thereof.

The information printing layer 4130 of the embodiment is formed of a thin film plate inserted between the first film 4100 and the second film 4120. A letter, a figure, and a picture are printed on the information printing layer 4130, and a transparent window should be secured in the information printing layer 4130 to expose a display of the portable terminal. Another example of the information printing layer 4130 may be a surface treatment layer directly printed, deposited, or coated on a bottom surface of the first film 4100 or an upper surface of the second film 4120.

The glue layer includes a first glue layer 4120 applied to a bottom surface of the first film 4100 and a second glue layer 4122 applied to a bottom surface of the second film 4120, and the information printing layer 4130 is situated between the first glue layer 4102 and the second glue layer 4122.

The first glue layer 4102 and the second glue layer 4122 are fused through thermal fusion to close the information printing layer 4130. Accordingly, since the information printing layer 4130 is not exposed to the outside, it is prevented from being worn out or damaged due to contact with the outside or exposed to ultraviolet rays so that its color is changed.

In the above-configured transmission protection layer, if a bottom surface of the second film 4120 is attached to the display window of the portable terminal, the second film 4120 is attached and bonded to the display window formed of a tempered glass due to a surface tension of the second film 4120 and an upper surface of the first film 4100 is exposed to the outside.

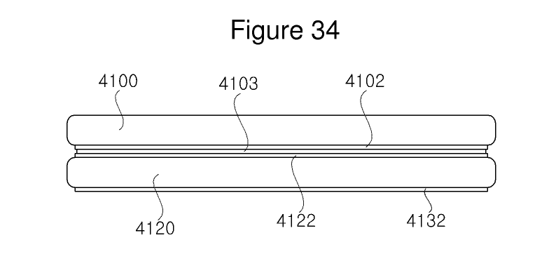

Meanwhile, in order that the transmission protection layer of the embodiment cannot be attached to the display window of the portable terminal but can be attached to a case such as a rear surface of the portable terminal, an ultraviolet glue layer 4132 may be coated on a bottom surface of the second film 4120 as in FIG. 34.

The ultraviolet hardener layer 4132 should be hardened by an ultraviolet hardener.

Hereinafter, a process of manufacturing the transmission protection layer of the embodiment will be described.

First, the first film 4100 and the second film 4120 of a synthetic resin material including PET are prepared. A hardness of an upper surface of the first film 4100 is increased by a hardener. The first glue layer 4102 and the second glue layer 4122 are applied to a bottom surface of the first film 4100 and an upper surface of the second film 4120, respectively, with reference to FIG. 32. Further, the information printing layer 4130 is inserted between the first film 4100 and the second film 4120. Further, the first film 4100 and the second film 4120 are combined with each other through lamination. Then, if the first film 4100 and the second film 4120 are pressed by a roller and thermally heated while the first film 4100 and the second film 4120 are bonded to each other, the first glue layer 4102 and the second glue layer 4122 are fused to close the information printing layer 4130, and the first film 4100 and the second film 4120 are bonded to each other. Thereafter, a protection paper is attached to a bottom surface of the second film 4120, and the finished transmission protection layer is cut into a desired shape. Thereafter, protection vinyl is attached to an upper surface of the first film 4100 and a bottom surface of the second film 4120 to be released while foreign substance is prevented from contacting an external object.

Meanwhile, when the transmission protection layer of the embodiment is to be bonded to the cover of the portable terminal instead of the display window formed of a tempered glass, an adhesive should be applied separately to a bottom surface of the second film 4120. To this end, as in FIG. 34, an ultraviolet glue layer 4132 is coated on a bottom surface of the second film 4120, and is hardened by an ultraviolet ray hardener.

The liquid crystal protection cover for a portable terminal of the present invention is not limited to the above embodiments, and may be variously modified within a range allowed by the technical spirit of the present invention.

The present invention can be mounted to an upper portion of a portable terminal such as a mobile phone to protect a liquid crystal part and a display window of the portable terminal while decorating the liquid crystal part and the display window, and interrupt electronic waves.

1. A liquid crystal protection cover coupled to an upper surface of a portable terminal having a liquid crystal part at an upper portion thereof and in which a display window covering an upper portion of the liquid crystal part is mounted to an upper surface thereof to protect the liquid crystal part and the display window, the liquid crystal protection cover comprising:
a transmission protection layer disposed on the display window; and
an adhesive layer disposed under the transmission protection layer to bond the transmission protection layer to an upper surface of the portable terminal.

2. The liquid crystal protection cover of claim 1, wherein a pattern layer is coupled to a lower surface of the transmission protection layer in an area other than an area corresponding to the liquid crystal part, an upper surface and a lower surface of the adhesive layer has a bonding property, the upper surface of the adhesive layer is bonded to a lower surface of the pattern layer, a lower release layer is coupled to the lower surface of the adhesive layer, and the lower surface of the adhesive layer is bonded to an upper surface of the display window of the portable terminal after the lower release layer is delaminated.

3. The liquid crystal protection cover of claim 1, wherein a pattern layer is coupled to an upper surface of the transmission protection layer in an area other than an area corresponding to the liquid crystal part, an upper surface and a lower surface of the adhesive layer has a bonding property, the upper surface of the adhesive layer is bonded to a lower surface of the transmission protection layer, a lower release layer is coupled to the lower surface of the adhesive layer, and the lower surface of the adhesive layer is bonded to an upper surface of the display window of the portable terminal after the lower release layer is delaminated.

4. The liquid crystal protection cover of claim 1, wherein the adhesive layer is detachably bonded to the display window of the portable terminal, and a bonding force of the lower surface of the adhesive layer is smaller than a bonding force of the upper surface of the adhesive layer so that the adhesive layer is bonded to a lower surface of the transmission protection layer when the transmission protection layer is separated from the display window.

5. The liquid crystal protection cover of claim 2, wherein a width of the adhesive layer is smaller than a width of the pattern layer at a portion where the adhesive layer is disposed under the pattern layer.

6. The liquid crystal protection cover of claim 1, wherein the transmission protection layer is formed of any one of a tempered glass, a transmitting plastic, and a synthetic resin film, and has a same size as that of the display window.

7. The liquid crystal protection cover of claim 2, wherein the pattern layer is formed on the transmission protection layer through printing or deposition.

8. The liquid crystal protection cover of claim 2, wherein an exposure hole for exposing at least one of a push button and speaker mounted to the portable terminal is formed in the transmission protection layer, and the pattern layer and the adhesive layer is empty at a portion corresponding to the exposure hole.

9. The liquid crystal protection cover of claim 8, wherein the exposure hole is formed to expose the push button to the outside, and a press button for pressing the push button is mounted to the exposure hole.

10. The liquid crystal protection cover of claim 2, wherein the pattern layer is coupled to the transmission protection layer, and the pattern layer is not coupled to the transmission protection layer in an area corresponding to a camera mounted to the portable terminal and in an area corresponding to the liquid crystal part.

11. The liquid crystal protection cover of claim 2, wherein the transmission protection layer is formed of a tempered glass, a non-coated film layer is attached to an entire lower surface of the transmission protection layer, and the pattern layer is coupled to a lower surface of the film layer in an area other than an area corresponding to the liquid crystal part.

12. The liquid crystal protection cover of claim 11, wherein an UV paint is applied to an upper surface or a lower surface of the film layer to form a convexo-concave portion.

13. The liquid crystal protection cover of claim 1, wherein a penetration hole having a size corresponding to a size of the liquid crystal part is formed in the transmission protection layer, and the adhesive layer is detachably bonded to the portable terminal.

14. The liquid crystal protection cover of claim 13, further comprising:
a transparent body inserted and coupled into the penetration hole of the transmission protection layer,
wherein the adhesive layer bonds a lower surface of the transmission protection layer and a lower surface of the transparent body to an upper surface of the portable terminal, an avoidance hole is formed in the adhesive layer, and a size of the avoidance hole is smaller than a size of the transparent body.

15. The liquid crystal protection cover of claim 13, further comprising:
a transparent body inserted and coupled into the penetration hole of the transmission protection layer,
wherein the transparent body comprises an insertion portion inserted into the penetration hole; and a lower end portion formed at a lower portion of the insertion portion, having a size larger than that of the insertion portion, and in which the transmission protection layer is positioned on a periphery upper portion thereof, and the adhesive layer comprises a first adhesive layer bonding a lower portion of the lower end portion to the portable terminal; and a second adhesive layer bonding the transmission protection layer to a peripheral upper surface of the lower end portion.

16. The liquid crystal protection cover of claim 14, wherein an opaque strip decoration is formed at a periphery of the transparent body, and the strip decoration covers an inner portion of the adhesive layer disposed under the transparent body.

17. The liquid crystal protection cover of claim 13, wherein the transmission protection layer is formed of a metal material.

18. The liquid crystal protection cover of claim 13, wherein the transmission protection layer comprises: a support portion having a recess on an upper surface thereof; and a decoration portion inserted and mounted into the recess.

19. The liquid crystal protection cover of claim 18, wherein a height of an outer side of the support portion forming the recess is lower than a height of the decoration portion.

20. The liquid crystal protection cover of claim 18, wherein a magnet is mounted between the decoration portion and the recess to couple the decoration portion to the recess.

21. The liquid crystal protection cover of claim 1, further comprising:
a shielding member coupled to the transmission protection layer or the display window to interrupt or absorb electronic waves generated in the portable terminal.

22. The liquid crystal protection cover of claim 21, wherein the shielding member comprises a shielding sheet disposed between the transmission protection layer and the display window to cover an upper surface of the display window other than the liquid crystal part, and the transmission protection layer is coupled to the display window through the shielding sheet.

23. The liquid crystal protection cover of claim 22, wherein the adhesive layer comprises a first adhesive portion coupling the transmission protection layer and the shielding member, and a second adhesive portion detachably coupling the shielding member to an upper surface of the display window.

24. The liquid crystal protection cover of claim 23, wherein the second adhesive portion comprises a tape opposite surfaces of which have a bonding property, and a bonding force of a surface of the second adhesive portion contacting the shielding member is stronger than a bonding force of a surface of the second adhesive portion contacting the display window.

25. The liquid crystal protection cover of claim 21, wherein the adhesive layer and the shielding member have a same configuration, and the shielding member has a bonding property to couple the transmission protection layer to the display window.

26. The liquid crystal protection cover of claim 21, wherein the shielding member comprises a conductive shielding net, the shielding net is coupled to the display window while covering a speaker of the portable terminal, a second through-hole inserted into the shielding net is formed in the transmission protection layer, and the transmission protection layer is coupled to the display window by the second adhesive portion.

27. The liquid crystal protection cover of claim 21, wherein the shielding member comprises: a shielding sheet disposed between the transmission protection layer to cover an upper surface of the display window other than the liquid crystal part; and a conductive shielding net coupled to the display window while covering a speaker of the portable terminal, the transmission protection layer is coupled to the display window while covering the shielding sheet, a first through-hole into which the shielding net is inserted is formed in the shielding sheet, and a second through-hole into which the shielding net is inserted is formed in the transmission protection layer.

28. The liquid crystal protection cover of claim 21, wherein the shielding member comprises a conductive ink layer applied to a lower surface of the transmission protection layer to interrupt or absorb electronic waves, and the conductive ink layer is coupled to an upper surface of the display window by the second adhesive portion.

29. The liquid crystal protection cover of claim 21, wherein the adhesive layer comprises a double-sided adhesive sheet coupled to a lower surface of the transmission protection layer to couple the transmission protection layer to the display window, the double-sided adhesive sheet is disposed adjacent to the shielding member horizontally, and the shielding member is disposed on a side opposite to a side of the display window where an antenna of the portable terminal is disposed.

30. The liquid crystal protection cover of claim 21, wherein the transmission protection layer is formed of any one of a tempered glass, a tempered plastic, and a synthetic resin film, and the shielding member is coupled to a lower surface of the transmission protection layer or an upper surface of the display window.

31. The liquid crystal protection cover of claim 1, wherein the transmission protection layer comprises: a first film; a second film facing the first film and bonded to the display window of the portable terminal; an information printing layer inserted between the first film and the second film; and a glue layer applied between the first film and the second film to bond the first film and the second film to each other, for closing a circumference of the information printing layer.

32. The liquid crystal protection cover of claim 31, wherein the information printing layer comprises a surface treatment layer printed, deposited, or coated on the first film or the second film.

33. The liquid crystal protection cover of claim 31, wherein the information printing layer is formed of a thin film plate of paper or a metal inserted between the first film and the second film.

34. The liquid crystal protection cover of claim 31, wherein an ultraviolet glue layer is coated on a bottom surface of the second film to be hardened.

35. A method of manufacturing a transmission protection layer of a liquid crystal protection cover for a portable terminal, the method comprising:
preparing a first film and a second film;
printing, coating, or depositing an information printing layer on the first film or the second film; and
combining the first film and the second film through lamination.

36. A method of manufacturing a transmission protection layer of a liquid crystal protection cover for a portable terminal, the method comprising:
preparing a first film and a second film;
applying a glue between the first film and the second film;
inserting an information printing layer between the first film or the second film; and
combining the first film and the second film through lamination.

37. The method of claim 35, further comprising: coating an ultraviolet ray glue layer on a bottom surface of the second film and hardening the ultraviolet ray glue layer with an ultraviolet ray hardener.
